(19) United States
(12) Patent Application Publication
(10) Pub. No.: US 2012/0131676 A1
(43) Pub. Date: May 24, 2012

(54) SECURITY MANAGEMENT METHOD IN VIRTUALIZED ENVIRONMENT, VIRTUAL SERVER MANAGEMENT SYSTEM, AND MANAGEMENT SERVER

(75) Inventor: Yoji Iwata, Yamato (JP)

(73) Assignee: Hitachi, Ltd

(21) Appl. No.: 13/387,663

(22) PCT Filed: Aug. 24, 2010
(86) PCT No.: PCT/JP2010/064258

§ 371 Date: Jan. 27, 2012

(30) Foreign Application Priority Data
Dec. 11, 2009 (JP) 2009-281190

(51) Int. Cl. G06F 21/00; G06F 11/00

(52) U.S. Cl. 726/24; 714/1; 714/E11.017

(57) ABSTRACT

Disclosed are a security management method in a virtualized environment, virtual server management system, and management server capable of improving security in the virtualized environment. A management server (101) stores virtual server management information for associating virtual servers (111), virtualization mechanism units (113), and virtual disks (117) in a storage unit, makes an inquiry to the virtualization mechanisms as to the operating states of whether the virtual servers are active or paused, and if a detection is made as a result of the inquiry that a state is paused, the virtual disk assigned to the paused virtual server is identified on the basis of the virtual server management information, and a virus scan is started for the identified virtual disk.

### FIELD OF THE INVENTION

The present invention relates to a security management method, a virtual server management system, and a management server capable of improving security in a server virtualized environment.

### BACKGROUND OF THE INVENTION

Virus scan is typically performed on general business systems on a periodic basis in order to ensure security (see Patent Document 1, for example). Meanwhile, improvement of virtualization-related technology allows a number of business systems to be collected together on a single physical server.

On the other hand, collection of general business systems in a virtualized environment is one of the causes which bring about a security problem. That is, a periodical virus scan on a collected system requires more CPU (Central Processing Unit) resource or memory resource and takes more time.

Virus scan is usually performed on general business systems during a time during which the virus scan does not affect regular business activities. If a plurality of business systems are brought together in a virtualized environment, the virus scan is performed on the plural business systems on a single physical server at about the same time period, which takes long time. Thus, the virus scan may not be finished during a time during which the regular business activities are not performed.

In addressing the above-described problems, there has been known a function in which a virus scan can be performed if a resource is available even during a time for the general business activities. The function is executed when, in general, a user has not used a business system for a certain period of time. Another problem is that, if a business system has not been used for a long time, the system will not be subjected to a periodic virus scan. In this case, it is necessary to periodically start up the virus scan.

### RELATED ART DOCUMENT

### Patent Document

[Patent Document 1] Japanese Laid-Open Patent Application, Publication No. 2008-140300

### SUMMARY OF THE INVENTION

### Problems to be Solved by the Invention

There has been known a server virtualization technology in which a virtual server is created in which a plurality of OSes (Operating Systems) can operate independently from each other on a single physical server. The server virtualization technology facilitates an effective use of a resource in a physical server such as a processor, a memory, and a disk device, by dividing the resource and allocating the divided sections to respective virtual servers. There has been known a virus scan technology in which a virus is detected in an OS. The virus scan technology uses “pattern matching technique” or “generic technique” to detect a virus. In the related art, a virus scan is performed in an appropriate OS, to thereby ensure security.

However, in ensuring security in a virtual server generated with the server virtualization technology, a virus scan on each OS of the virtual server as performed in the related art is not efficient.

One of the problems to be solved is a method of virus scan. A virus scan on each of the OS of a virtual server takes time because respective OSes in the virtual server compete for the resource with each other.

Another problem is that security of an OS on a virtual server which is not running cannot be ensured. A virus scan operates in the OS. In order to ensure security, it is necessary to periodically start up a virtual server which is not running.

The present invention has been made in an attempt to solve the above-described problems and to provide a security management method, a virtual server management system, and a management server capable of improving security in a server virtualized environment.

### Means for Solving the Problem

In order to solve the problems, a security management method in a virtualized environment is provided. In the security management method, a management server performs a virus scan on a virtual disk and manages security of a system. In the security management method, one or more server devices (which may be, for example, physical servers 114) are coupled to disk devices (which may be, for example, disk devices 115); the server device includes a virtualization mechanism part (which may be, for example, a virtualization mechanism part 113) which is capable of creating and managing one or more virtual servers (which may be, for example, virtual servers 111); the virtual server has a virtual disk (which may be, for example, a virtual disk 117) to which an area of the disk device is allocated; and the management server is coupled to the server device and the disk device via a network.

The present invention is characterized in that the management server: stores, in a storage part (which may be, for example, a memory 201A), virtual server management information (which may be, for example, a virtual server management table 107) in which the virtual server, the virtualization mechanism part, the virtual disk, and a state of a virus scan in the virtual disk are associated with each other; inquires of the virtualization mechanism part for an operational state of the virtual server which indicates whether the virtual server is started up or is inactive; identifies, if the operational state in response to the inquiry is detected as inactive, the virtual disk allocated to the inactive virtual server based on the virtual server management information; and starts a virus scan on the identified virtual disk; and starts a virus scan on the identified virtual disk.

The present invention is also characterized in that results of virus scans performed on the same files in the virtual disks in all of the virtual servers managed by the management server are shared. This can reduce a time required for a virus scan in the system as a whole.

### Effect of the Invention

In the present invention, security in a virtualized environment can be improved.

### BRIEF DESCRIPTION OF THE DRAWINGS

FIG. 1 is a general block diagram illustrating a virtual server management system of the present invention.

FIG. 2 is a detailed diagram illustrating a configuration of a management server according to a first embodiment.

FIG. 3 is a detailed diagram illustrating a configuration of a physical server.

FIG. 4 is an explanatory diagram illustrating an example of a physical server management table.

FIG. 5 is an explanatory diagram illustrating an example of a virtual server management table.

FIG. 6 is an explanatory diagram illustrating an example of a file management table.

FIG. 7 is an explanatory diagram illustrating an outline of an inactive detection processing.

FIG. 8 is an explanatory diagram illustrating an outline of a start-up detection processing.

FIG. 9 is an explanatory diagram illustrating an outline of a start-up coordination processing.

FIG. 10 is an explanatory diagram illustrating an outline of a virus detection processing.

FIG. 11 is an explanatory diagram illustrating an outline of a file management table update processing.

FIG. 12 is an explanatory diagram illustrating an outline of a physical server management table/virtual server management table addition update processing.

FIG. 13 is a flowchart illustrating an overall processing performed by a virtual server monitor part.

FIG. 14 is a flowchart illustrating a processing performed by a file transmit receive part of the virtual server monitor part.

FIG. 15 is a flowchart illustrating a processing performed by a start-up detection part of the virtual server monitor part.

FIG. 16 is a flowchart illustrating a processing performed by an inactive detection part of the virtual server monitor part.

FIG. 17 is a flowchart illustrating a processing performed by a virtual server addition update part of the virtual server monitor part.

FIG. 18 is a flowchart illustrating a processing performed by a file processing part.

FIG. 19 is a flowchart illustrating a processing performed by a scan start part of the file processing part.

FIG. 20 is a flowchart illustrating a processing performed by a scan suspend part of the file processing part.

FIG. 21 is a flowchart illustrating a processing performed by a management table processing part according to the first embodiment.

FIG. 22 is a flowchart illustrating the processing performed by the management table processing part according to the first embodiment.

FIG. 23 is a flowchart illustrating a processing performed by a file entry addition update part of the management table processing part.

FIG. 24 is a flowchart illustrating a processing performed by a file entry extraction part of the management table processing part.

FIG. 25 is a flowchart illustrating a processing performed by a server entry addition update part of the management table processing part.

FIG. 26 is a flowchart illustrating a processing performed by a server entry extraction part of the management table processing part.

FIG. 27 is a flowchart illustrating a processing performed by a file identifier generation part of the management table processing part.

FIG. 28 is a detailed diagram illustrating a configuration of a management server according to a second embodiment.

FIG. 29 is a flowchart illustrating a processing performed by a management table processing part according to the second embodiment.

FIG. 30 is a flowchart illustrating the processing performed by the management table processing part according to the second embodiment.

FIG. 31 is a flowchart illustrating a processing performed by a file entry coordination part of the management table processing part.

### EMBODIMENTS FOR CARRYING OUT THE INVENTION

Next is described in detail embodiments of the present invention with reference to related drawings.

### First Embodiment

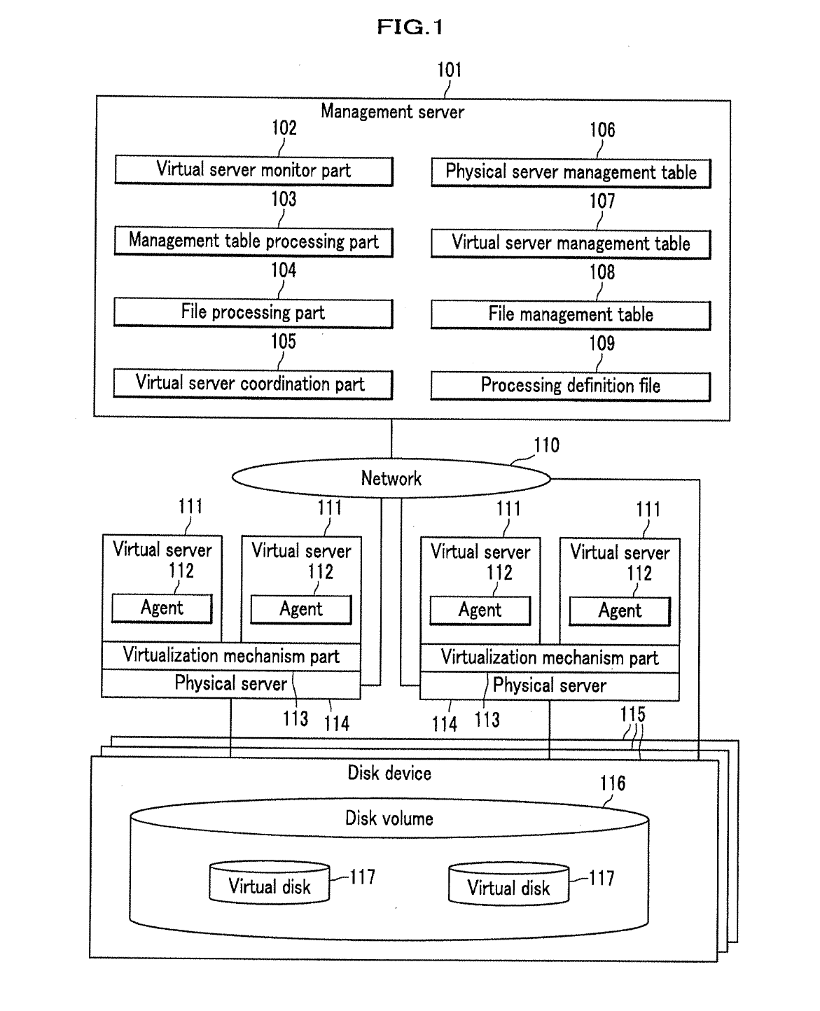

FIG. 1 is a general block diagram illustrating a virtual server management system of the present invention. As shown in FIG. 1, the virtual server management system includes a management server 101, and one or more physical servers 114 (which may also be referred to as server devices), which are coupled to each other via a network 110. The virtual server management system also includes one or more disk devices 115 which are coupled to the physical servers 114.

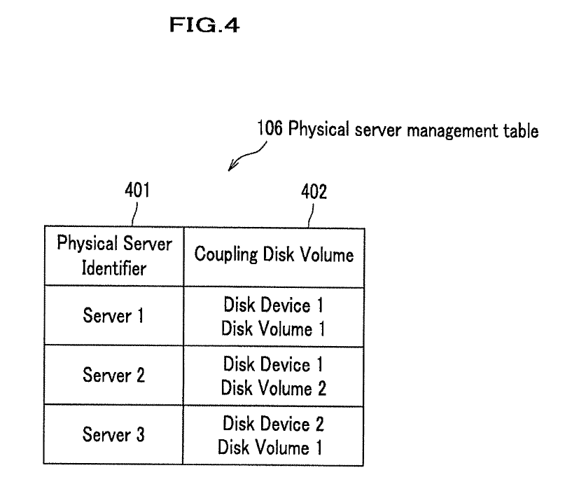

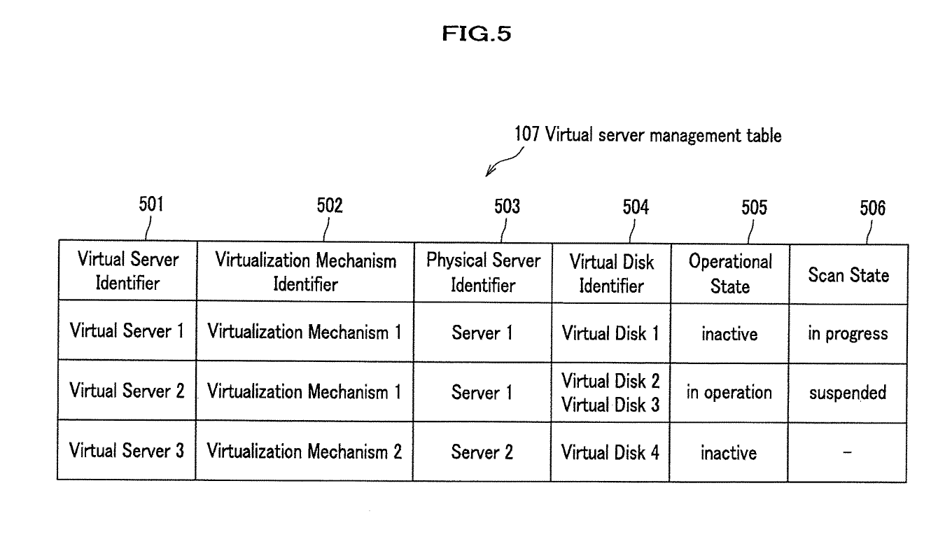

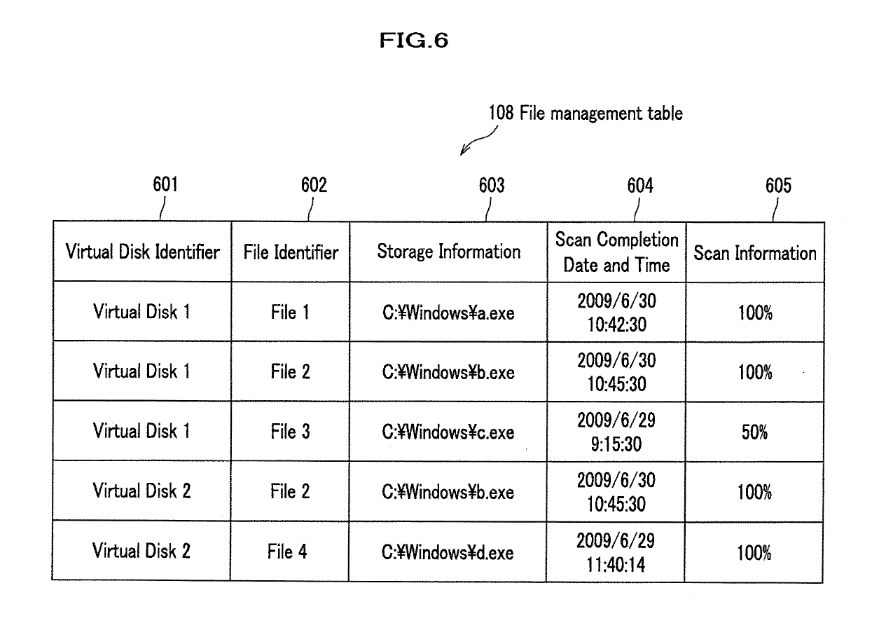

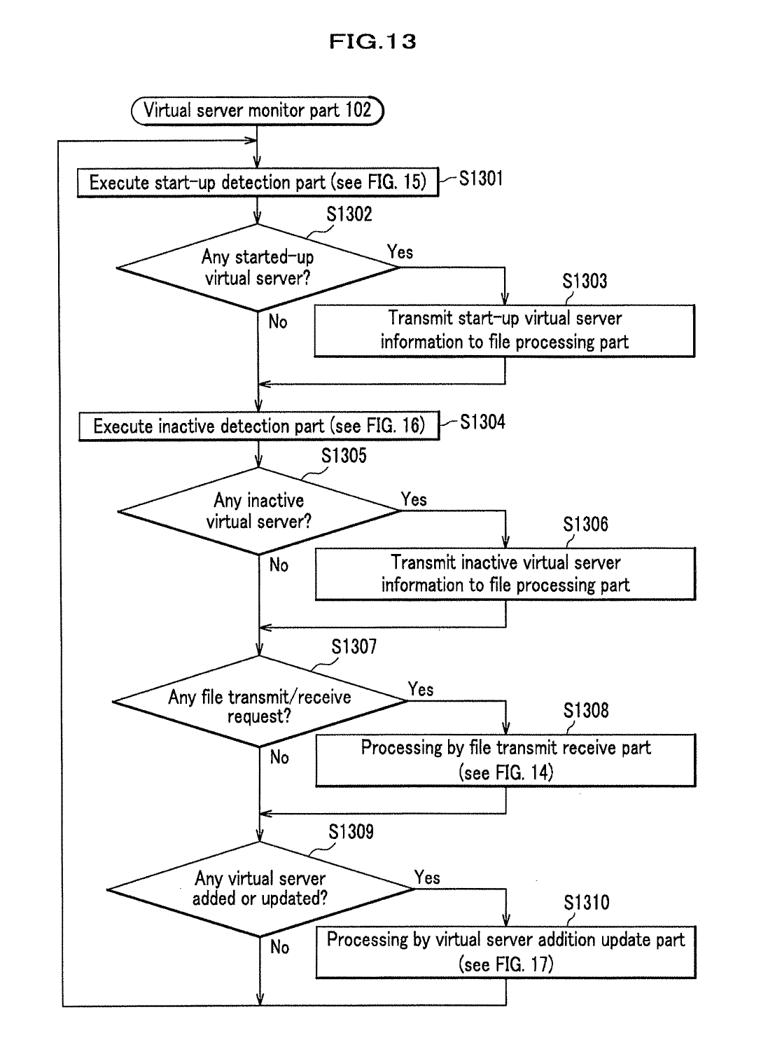

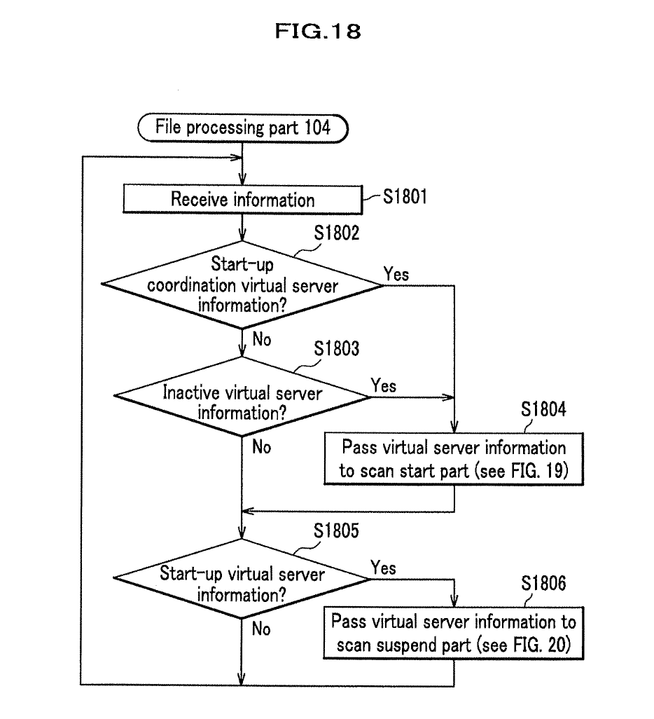

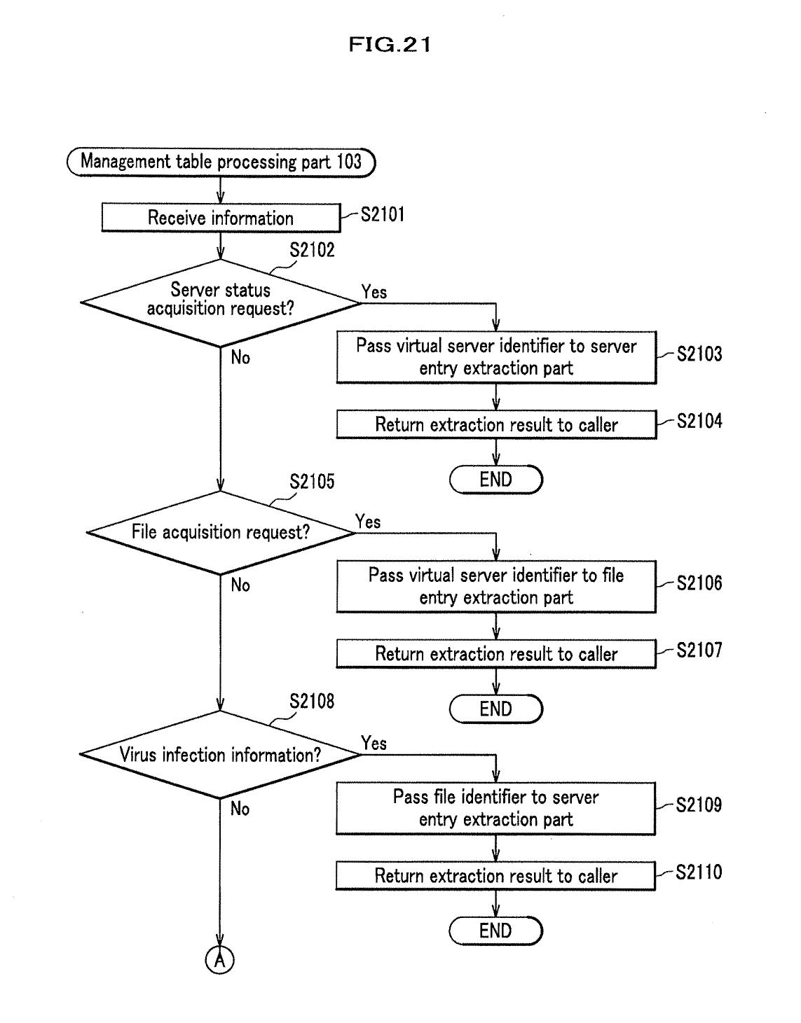

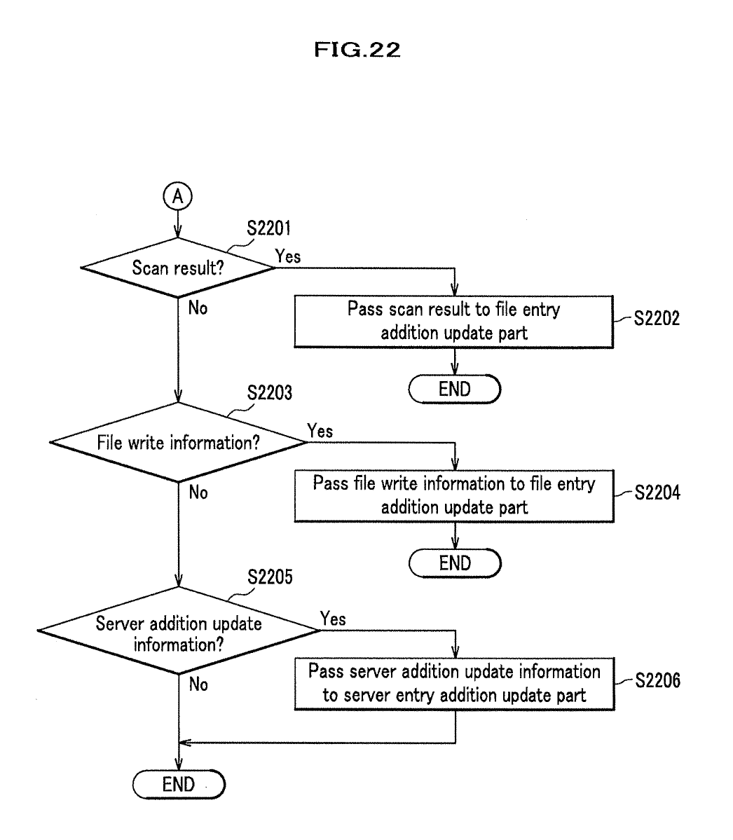

The management server 101 serves as a control center in improving security in a virtualized environment. The management server 101 includes a virtual server monitor part 102 (see FIG. 13), a management table processing part 103 (see FIG. 21 and FIG. 22), a file processing part 104 (see FIG. 18), and a virtual server coordination part 105. The management server 101 also includes various tables, namely, a physical server management table 106 (see FIG. 4), a virtual server management table 107 (see FIG. 5) (which may also be referred to as a virtual server management information), a file management table 108 (see FIG. 6) (which may also be referred to as a file management information), and a processing definition file 109.

The physical server 114 includes a virtualization mechanism part 113. The virtualization mechanism part 113 includes a plurality of virtual servers 111. Each of the virtual servers 111 has an agent 112. The physical server 114 has a disk device 115 made up of a plurality of disk volumes 116. Each of the disk volumes 116 has a plurality of virtual disks 117. The disk device 115 may be of a server built-in type or may be an external device via a fiber channel.

The virtual server monitor part 102 of the management server 101 receives and passes data on a start-up or an inactive state of a virtual server and other various types of information. The management table processing part 103 adds or updates a file entry and adds or updates a server entry. The file processing part 104 controls a start-up or a suspension of a virus scan (which may be simply referred to as a scan hereinafter). The virtual server coordination part 105 manages the virtualization mechanism part 113 and the agent 112.

The physical server management table 106 stores therein resource information of the physical server 114 concerning a disk device coupled to the physical server 114. The virtual server management table 107 stores therein configuration information and various states concerning the virtual server 111. The file management table 108 stores therein file information on a file stored in the virtual disk 117, a time and date of a virus scan, and a state of the virus scan. The processing definition file 109 stores therein a condition for performing a virus scan on the virtual disk 117 or a file extraction condition for extracting a file targeted for a virus scan from the file management table 108.

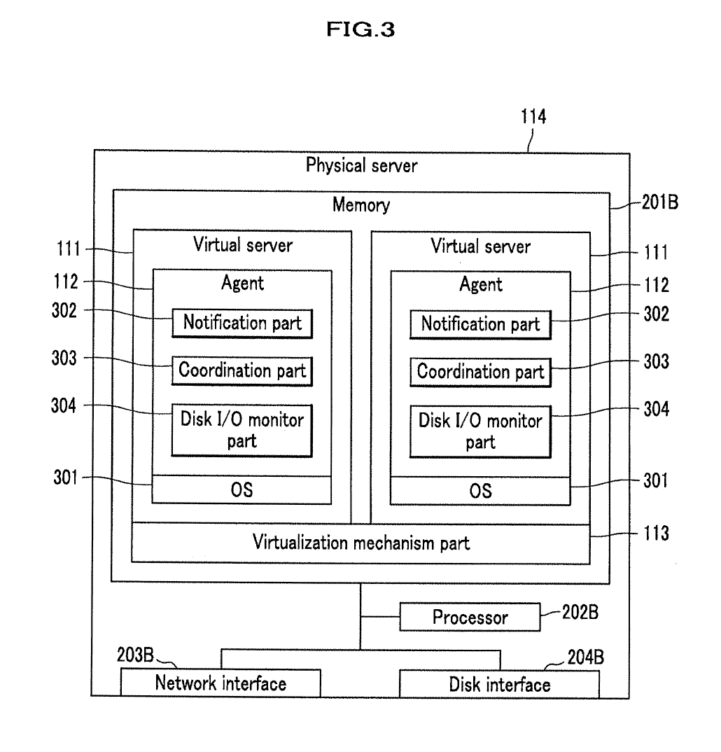

This embodiment exemplifies a virus scan which is run by the management server 101 according to a start-up state or an inactive state of the virtual server 111 as well as processing steps of performing the virus scan. Note that the start-up state used herein means a state in which the virtual server 111 is stored in a memory 201B (see FIG. 3), and the inactive state means a state in which the virtual server 111 is not stored in the memory 201B.

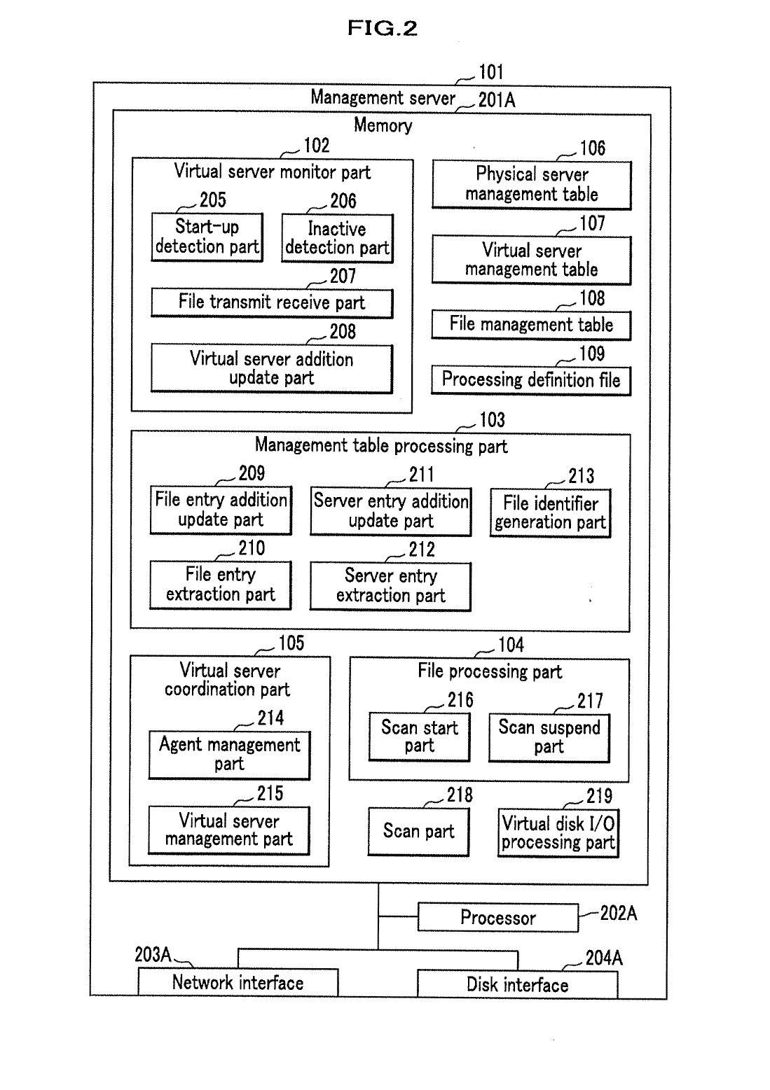

FIG. 2 is a detailed diagram illustrating a configuration of a management server according to the first embodiment. The management server 101 is configured by a memory 201A, a processor 202A, a network interface 203A, and a disk interface 204A. The memory 201A stores therein various programs, namely, the virtual server monitor part 102, the management table processing part 103, the file processing part 104, the virtual server coordination part 105, a scan part 218, and a virtual disk I/O processing part 219, as well as various tables, namely, the physical server management table 106, the virtual server management table 107, the file management table 108, and the processing definition file 109. Note that the I/O stands for Input/Output.

The virtual server monitor part 102 includes a start-up detection part 205, an inactive detection part 206, a file transmit receive part 207, and a virtual server addition update part 208.

The management table processing part 103 includes programs, namely, a file entry addition update part 209, a file entry extraction part 210, a server entry addition update part 211, a server entry extraction part 212, and a file identifier generation part 213.

The file processing part 104 includes programs, namely, a scan start part 216 and a scan suspend part 217. The virtual server coordination part 105 includes an agent management part 214 and a virtual server management part 215. In this embodiment, the file processing part 104 includes not the scan part 218 but the scan start part 216 and the scan suspend part 217. However, the configuration is not limited to this. For example, the file processing part 104 may include all of the scan start part 216, the scan suspend part 217, and the scan part 218 for serving as the file processing part 104 as a whole.

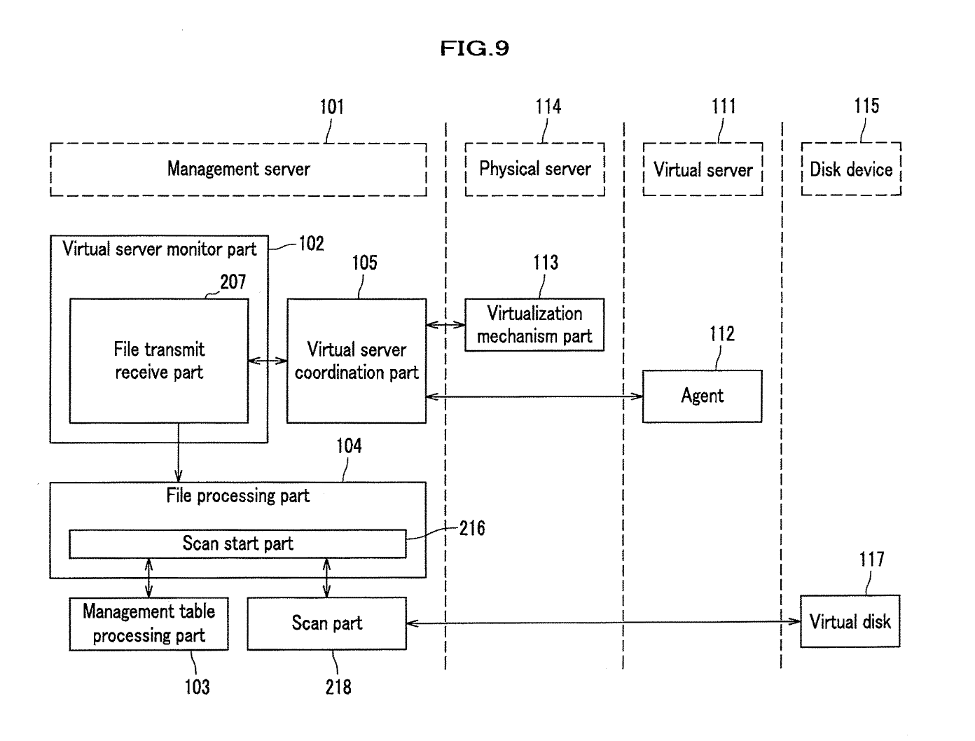

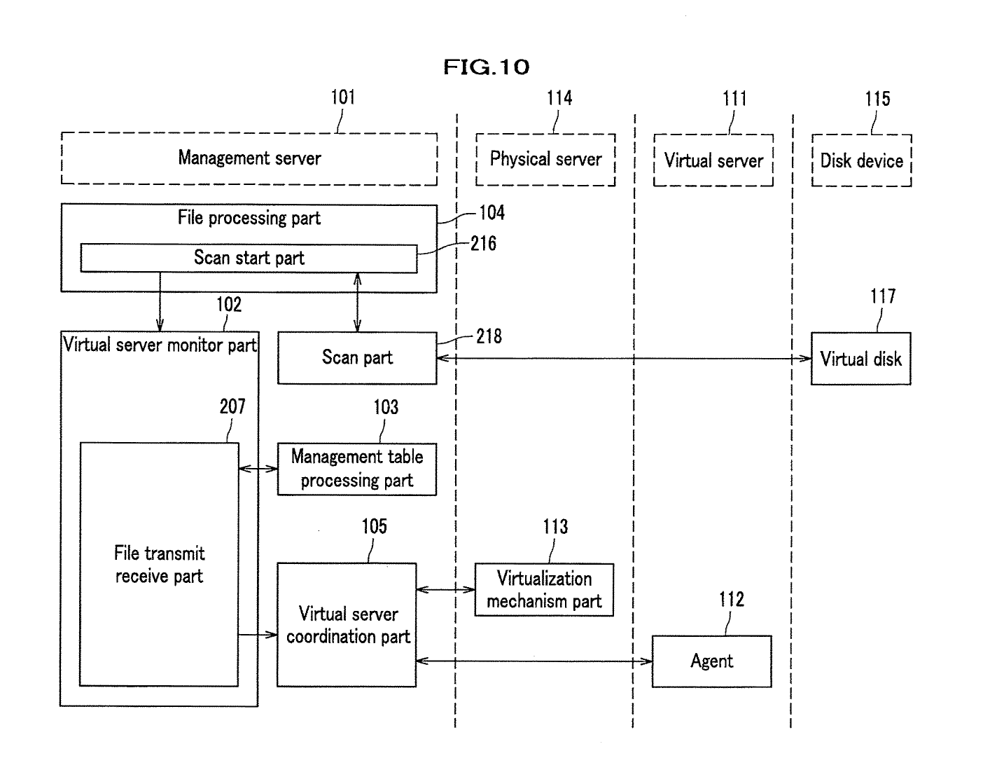

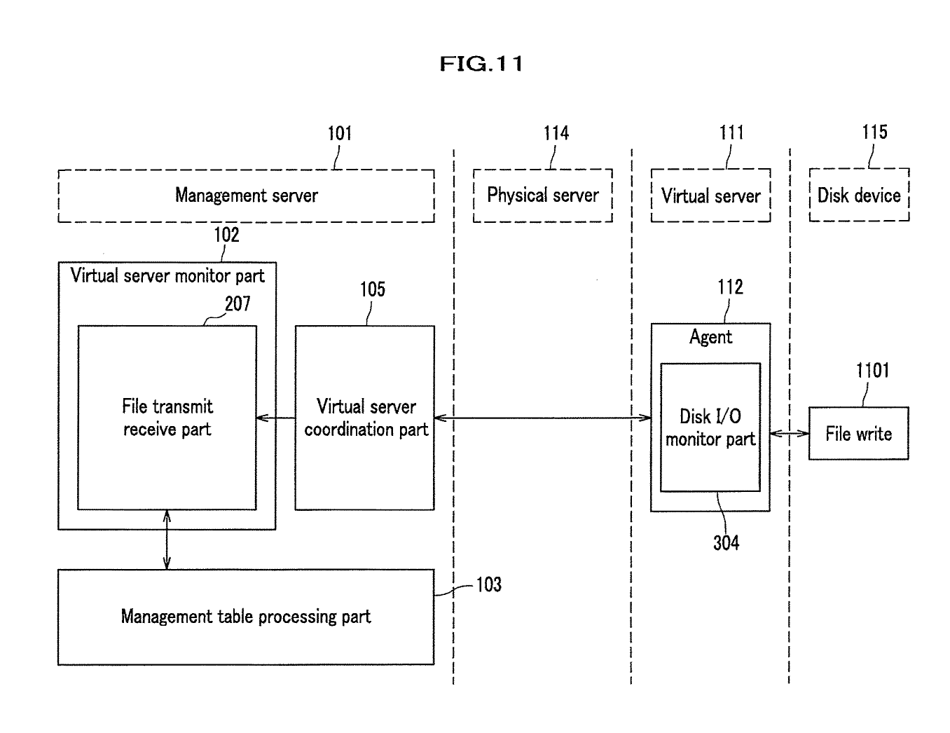

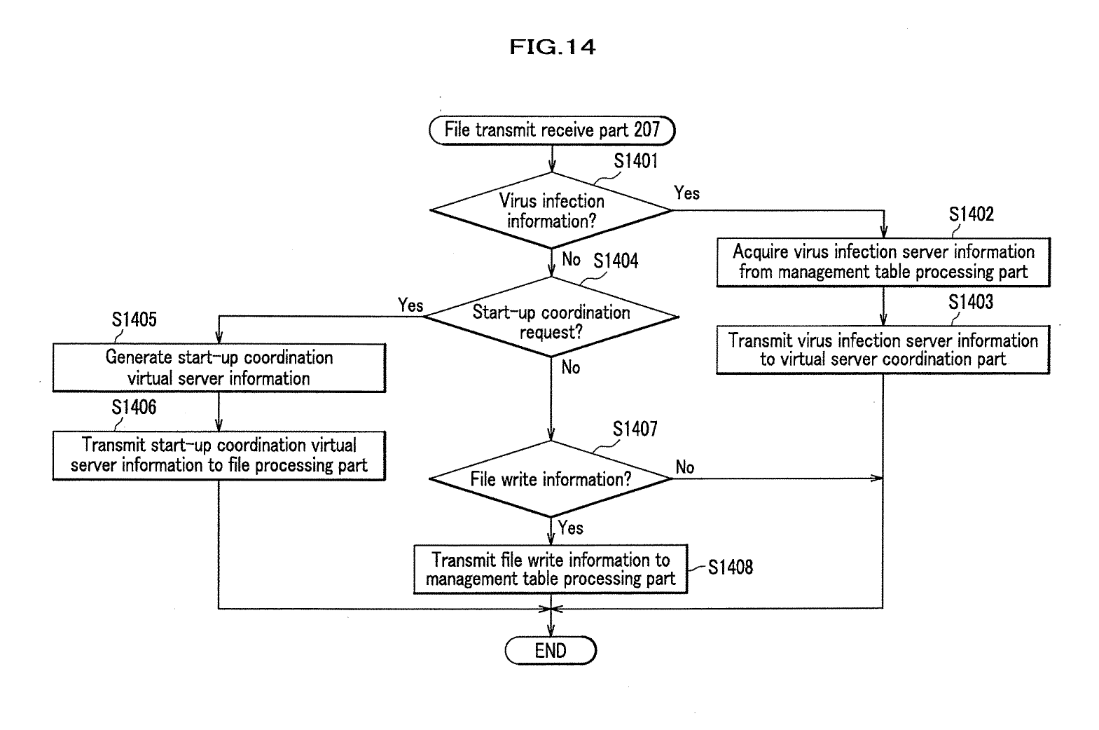

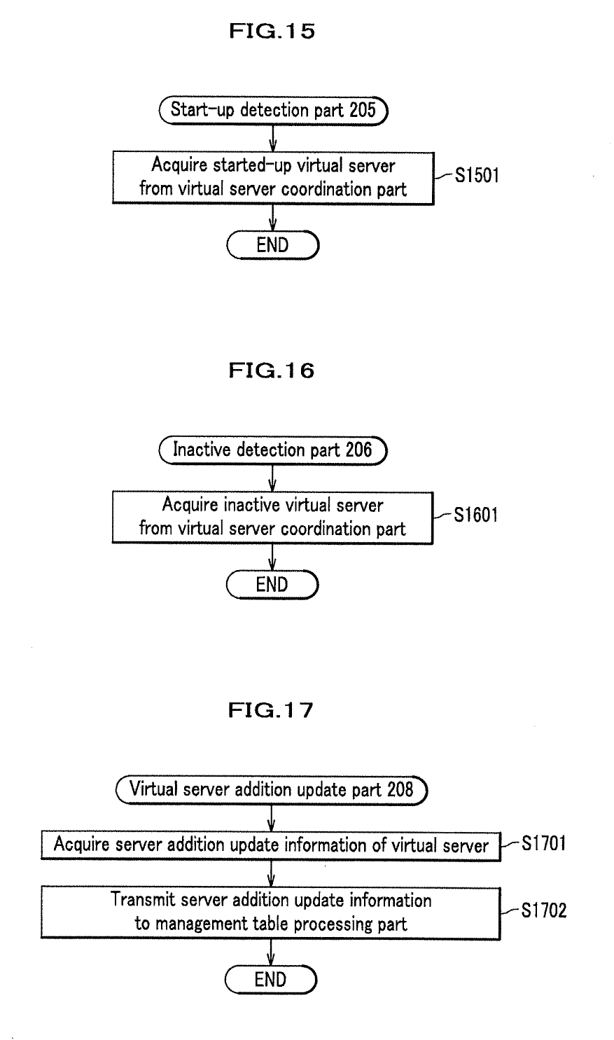

The start-up detection part 205 (see FIG. 15) and the inactive detection part 206 (see FIG. 16) of the virtual server monitor part 102 (see FIG. 13) coordinate with the agent management part 214 or the virtual server management part 215 included in the virtual server coordination part 105 and detect whether or not the started-up virtual server 111 or the inactive virtual server is present. Note that the started-up virtual server 111 herein means the virtual server 111 which has been inactive is currently started up. The inactive virtual server 111 herein means the virtual server 111 which has been started up is currently inactive. The file transmit receive part 207 (see FIG. 14) receives virus infection information, a start-up coordination request, and file write information, determines what is the received information or request, and assigns the received information or request to appropriate processing parts (see FIG. 9, FIG. 10, and FIG. 11). The virtual server addition update part 208 (see FIG. 17) adds the newly-created virtual server 111 or updates a state of the existent virtual server 111, to the physical server management table 106 and the virtual server management table 107.

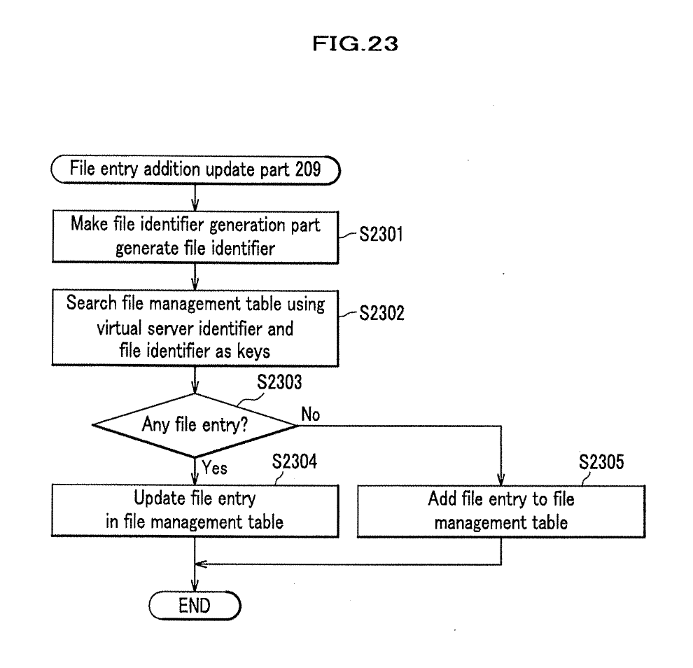

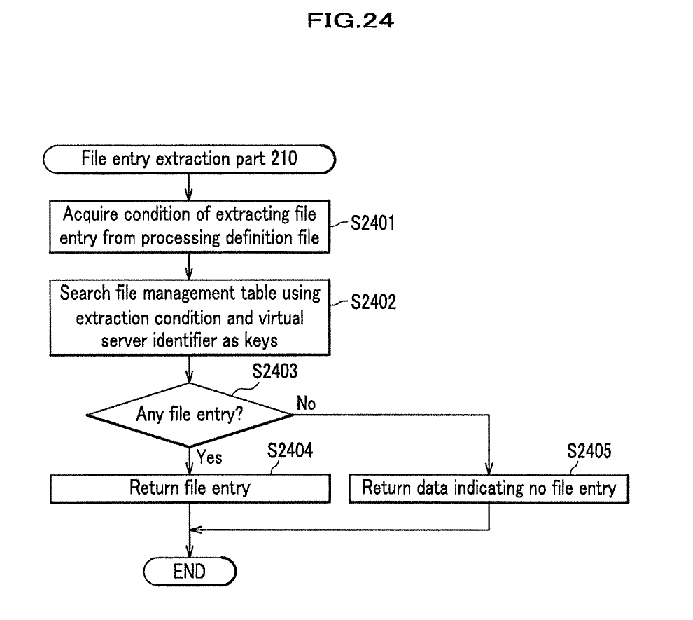

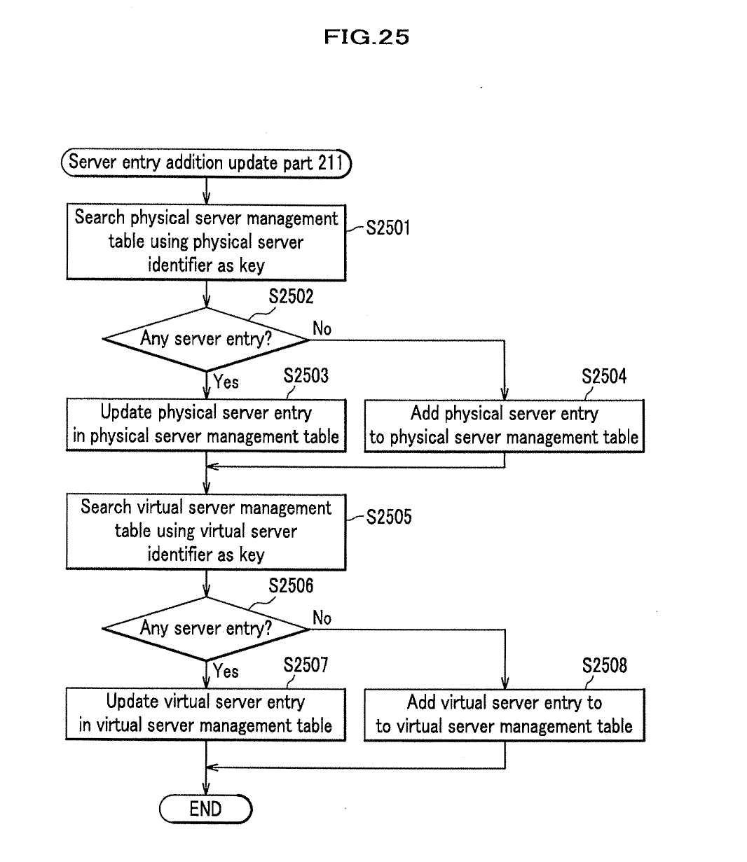

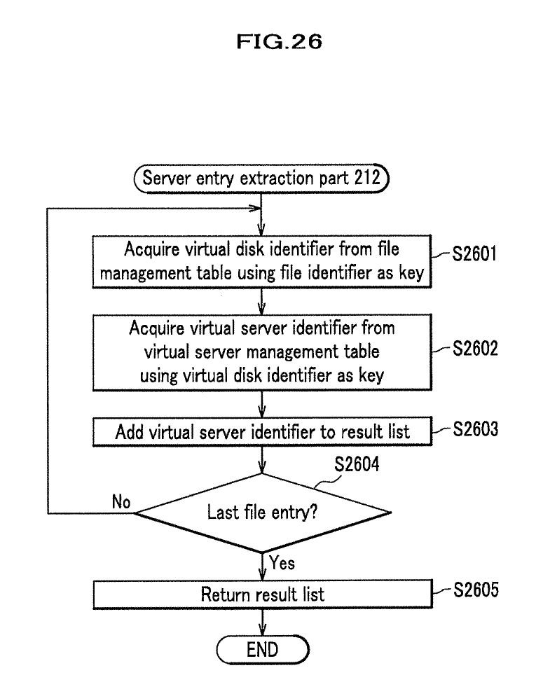

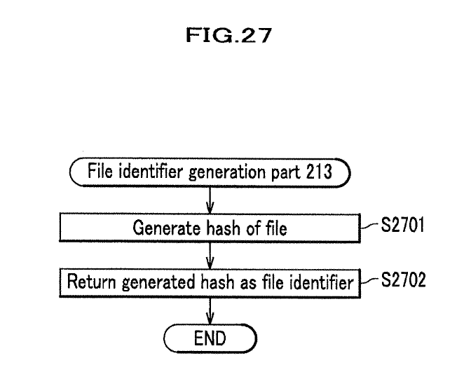

The file entry addition update part 209 (see FIG. 23) of the management table processing part 103 (see FIG. 21 and FIG. 22) adds a file written in the virtual disk 117 or updates a scan result, to the file management table 108. The file entry extraction part 210 (see FIG. 24) extracts a file from the file management table 108 according to a file extraction condition of the processing definition file 109. The server entry addition update part 211 (see FIG. 25) adds or updates a physical server and a virtual server to the physical server management table 106 and the virtual server management table 107, respectively. The server entry extraction part 212 (see FIG. 26) identifies a virtual server containing a specific file from the virtual server management table 107 and the file management table 108. The file identifier generation part 213 (see FIG. 27) generates an identifier unique to each file. However, if a file has contents identical to those of another, the same identifier is generated.

The agent management part 214 coordinates with the coordination part 303 of the agent 112 of the virtual server 111. The virtual server management part 215 coordinates with the virtualization mechanism part 113. The agent management part 214 or the virtual server management part 215 monitors a start-up or an inactive state of the virtual server 111.

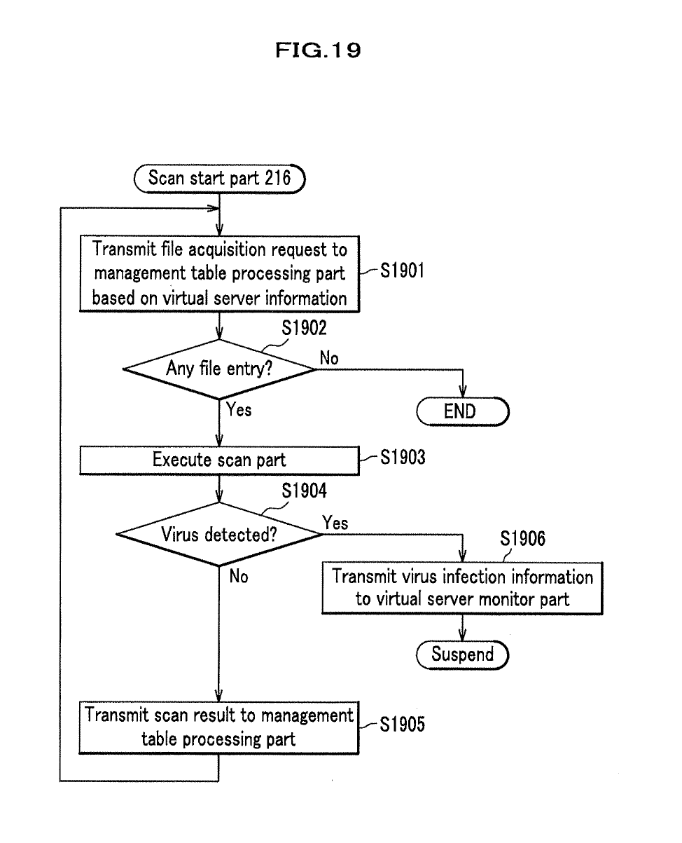

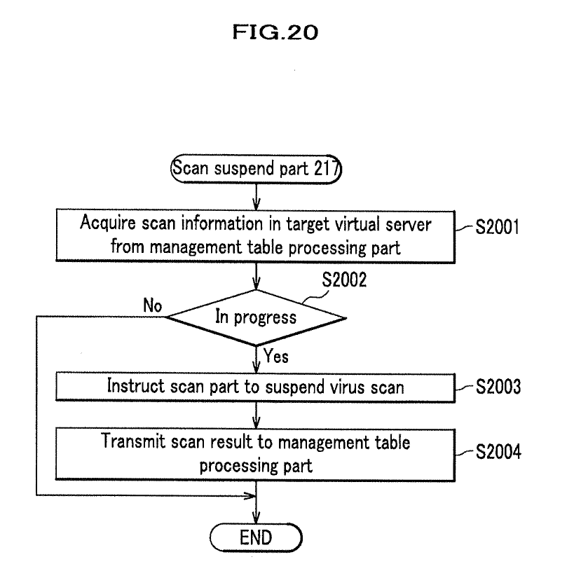

The scan start part 216 (see FIG. 19) of the file processing part 104 (see FIG. 18) starts a scan on the virtual disk 117, and more specifically, starts a virus scan on a file in the virtual disk 117 using the scan part 218. The scan suspend part 217 (see FIG. 20) suspends a virus scan which is running on a file by the scan part 218.

The scan part 218 performs a virus scan on a file in the virtual disk 117 using the virtual disk I/O processing part 219. The virtual disk I/O processing part 219 identifies a file in the virtual disk 117 and performs an I/O processing. The virtual disk I/O processing part 219 can be included in the scan part 218.

The processor 202A executes various programs stored in the memory 201A, such as the virtual server monitor part 102, the management table processing part 103, the file processing part 104, the virtual server coordination part 105, the scan part 218, and the virtual disk I/O processing part 219. The execution realizes management and coordination of the virtual server 111, a transmit and receive processing of file information, and each processing of a virus scan.

The management and coordination of the virtual server 111, the transmit and receive processing of file information, and each processing of a virus scan of the virtual server 111 are embodied by executing the each program by the processor 202A. The each program can also be realized by hardware in which, for example, the virtual server monitor part 102, the management table processing part 103, the file processing part 104, the virtual server coordination part 105, the scan part 218, the virtual disk I/O processing part 219, or the like serve as processing parts which performs corresponding processings in form of an integrated circuit. Further, the memory 201B (see FIG. 3) of the physical server 114 can operate the virtual server monitor part 102, the management table processing part 103, the file processing part 104, the virtual server coordination part 105, the scan part 218, and the virtual disk I/O processing part 219 each stored in the memory 201A of the management server 101.

The network interface 203A is an interface for coupling the network 110. Information on the started-up or inactive virtual server 111 or the like is transferred via the network interface 203A. The disk interface 204A is an interface for making an access to the disk device 115.

FIG. 3 is a detailed diagram illustrating a configuration of the physical server 114. The physical server 114 includes a memory 201B, a processor 202B, a network interface 203B, and a disk interface 204B. The memory 201B includes the virtual server 111 and the virtualization mechanism part 113. The processor 202B executes various programs such as the virtual server 111 and the virtualization mechanism part 113 stored in the memory 201B, to thereby perform each processing of the virtual server 111. The virtualization mechanism part 113 can also be executed as a program in an OS installed on the physical server 114.

Each of the virtual servers 111 with the OS 301 installed thereon can operate independently from each other. The agent 112 is installed in the OS 301. The agent 112 includes a notification part 302, a coordination part 303, and a disk I/O monitor part 304.

The notification part 302 notifies a user of a result of a virus scan or the like. The coordination part 303 receives and transmits information via the virtual server coordination part 105 and the network 110. The disk I/O monitor part 304 detects that the OS 301 reads from or writes to the virtual disk 117.

Next are described various tables.

FIG. 4 is an explanatory diagram illustrating an example of the physical server management table 106. The physical server management table 106 includes a physical server identifier 401 which is an identifier of the physical server 114 and a coupled disk volume 402 which is the disk volume 116 coupled to the physical server 114. The physical server identifier 401 contains plural pieces of information if plural physical servers 114 are present. More specifically, if the physical server identifier 401 is “Server 1”, the coupled disk volume 402 is “Disk Volume 1” of “Disk Device 1”. If the physical server identifier 401 is “Server 2”, the coupled disk volume 402 is “Disk Volume 2” of “Disk Device 1”. Note that the server entry addition update part 211 adds new data to or updates existent data in the physical server management table 106.

In this embodiment, a set of information made up of the physical server identifier 401 and the coupled disk volume 402 shown in a row of the physical server management table 106 is hereinafter referred to as a physical server entry. If a physical server entry is newly added, it means that a new row is added to the physical server management table 106.

FIG. 5 is an explanatory diagram illustrating an example of the virtual server management table 107. The virtual server management table 107 includes: a virtual server identifier 501 which is an identifier of the virtual server 111; a virtual mechanism identifier 502 which is an identifier of the virtualization mechanism part 113; a physical server identifier 503 which is an identifier of the physical disk 114; a virtual disk identifier 504 which is an identifier of the virtual disk 117; an operational state 505 which shows an operational state of the virtual server 111; and a scan state 506 which shows a state of a scan.

The virtual server identifier 501 contains information which uniquely determines the virtual server 111. If a plurality of virtual servers 111 are present, plural pieces of information are stored therein. The virtual mechanism identifier 502 contains information which uniquely determines the virtualization mechanism part 113. The physical server identifier 503 contains information which uniquely determines the physical server 114. The virtual disk identifier 504 contains information which uniquely determines the virtual disk 117. If a plurality of the virtual disks 117 are coupled to the virtual server 111, plural pieces of information are stored therein. The operational state 505 contains, for example, information such as “in operation” and “inactive”. The scan state 506 contains, for example, information such as “in progress” and “suspended”. Note that the server entry addition update part 211 adds new data to or updates existent data in the virtual server management table 107.

More specifically, Virtual Server 1 includes Virtualization Mechanism 1 (Virtualization Mechanism Part 1), is on Physical Server 1, and has Virtual Disk 1 assigned thereto. Because Virtual Server 1 is in an inactive state, a virus scan on Virtual Disk 1 assigned to Virtual Server 1 is running (in progress). Virtual Server 2 includes Virtualization Mechanism 2 (Virtualization Mechanism Part 2), is on Physical Server 1, and has Virtual Disk 2 and Virtual Disk 3 assigned thereto. Virus scans on Virtual Disk 2 and Virtual Disk 3 started when Virtual Server 2 was inactive. However, Virtual Server 2 is currently in operation, the virus scans on Virtual Disk 2 and Virtual Disk 3 are have been suspended.

In this embodiment, a set of information made up of the virtual server identifier 501, the virtual mechanism identifier 502, the physical server identifier 503, the virtual disk identifier 504, the operational state 505, and the scan state 506 in a row of the virtual server management table 107 is hereinafter referred to as a virtual server entry. If a virtual server entry is newly added, it means that a new row is added to the virtual server management table 107.

FIG. 6 is an explanatory diagram illustrating an example of the file management table 108. The file management table 108 includes a virtual disk identifier 601 which is an identifier of the virtual disk; a file identifier 602 which is an identifier of a file; storage information 603; a scan completion date and time 604; and scan information 605. The virtual disk identifier 601 contains information which uniquely determines the virtual disk 117. The file identifier 602 contains information which uniquely determines a file stored in the virtual disk 117. If a file is stored in one location in one virtual disk 117 and the same file is also is stored in another location in the same virtual disk 117 or is stored in another virtual disk 117, the same identifier is generated. The storage information 603 shows where a file is stored in the virtual disk 117. The scan completion date and time 604 shows a date and a time when the last virus scan was run. The scan information 605 shows a current running state of a virus scan and contains information for resuming a suspended virus scan or the like. Note that the file entry addition update part 209 adds new data to or updates existent data in the file management table 108.

In this embodiment, a set of information made up of the virtual disk identifier 601, the file identifier 602, the storage information 603, the scan completion date and time 604, and the scan information 605 in a row of the file management table 108 is hereinafter referred to as a file entry. If a file entry is newly added, it means that a new row is added to the file management table 108.

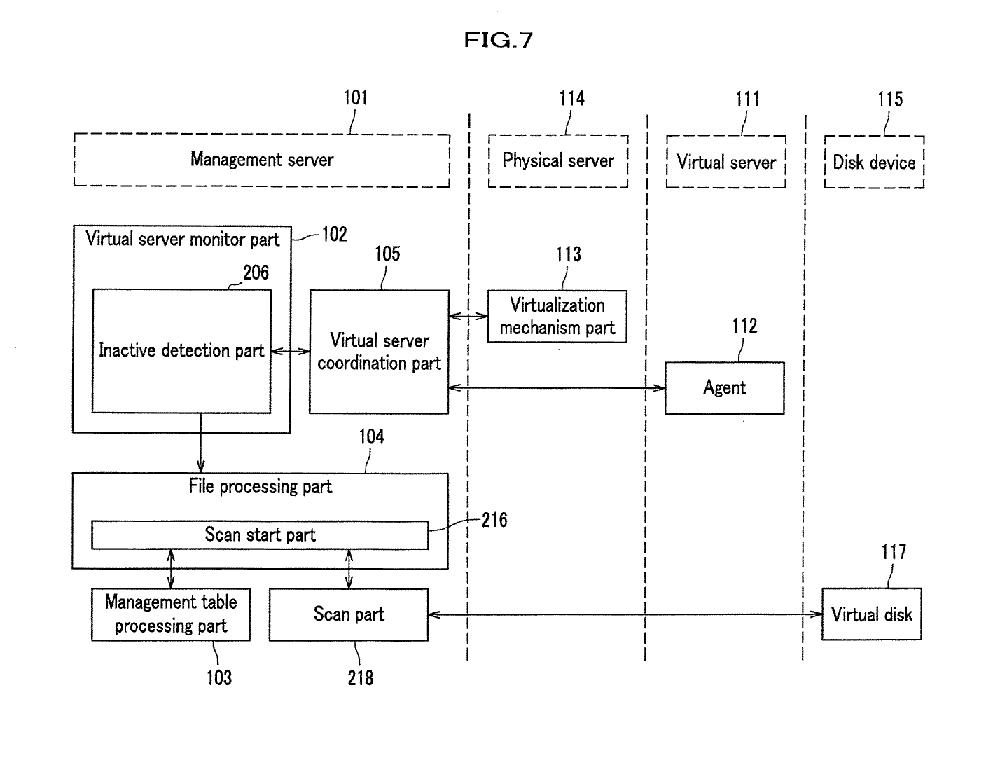

FIG. 7 is an explanatory diagram illustrating an outline of an inactive detection processing. The virtual server monitor part 102 periodically checks the virtual server 111 in an inactive state using the inactive detection part 206. The inactive detection part 206 determines the virtual server 111 in the inactive state by detecting that a communication with the agent 112 is not available using the virtual server coordination part 105. The inactive detection part 206 can also check the inactive virtual server 111 by making an inquiry to the virtualization mechanism part 113 via the virtual server coordination part 105 at regular time intervals or on request from an administrator. The virtualization mechanism part 113 may notify the virtual server coordination part 105 of a detection of the inactive virtual server 111. If the inactive detection part 206 detects the inactive virtual server 111, the inactive detection part 206 transmits inactive virtual server information to the file processing part 104. Note that the inactive virtual server information is, more specifically, a virtual server identifier of the inactive virtual server 111.

Upon receipt of the inactive virtual server information, the file processing part 104 of the management server 101 passes appropriate virtual server information (for example, a virtual server identifier or a virtual disk identifier) to the scan start part 216. The scan start part 216 transmits a file acquisition request to the management table processing part 103 based on the virtual server information.

Upon receipt of the file acquisition request, the management table processing part 103 of the management server 101 extracts a file entry from the file management table 108 and transmits the file entry to the scan start part 216. Upon receipt of a result of the file acquisition request, the scan start part 216 performs a virus scan on the virtual disk 117 using the scan part 218. The scan part 218 returns a result of the virus scan (which may also be referred to as a scanned result) to the scan start part 216. The scan start part 216 transmits the scanned result to the management table processing part 103. Upon receipt of the scanned result, the management table processing part 103 updates the virtual server management table 107 and the file management table 108. The scan start part 216 continues performing the virus scan until no more file entry is extracted as the result of the file acquisition request.

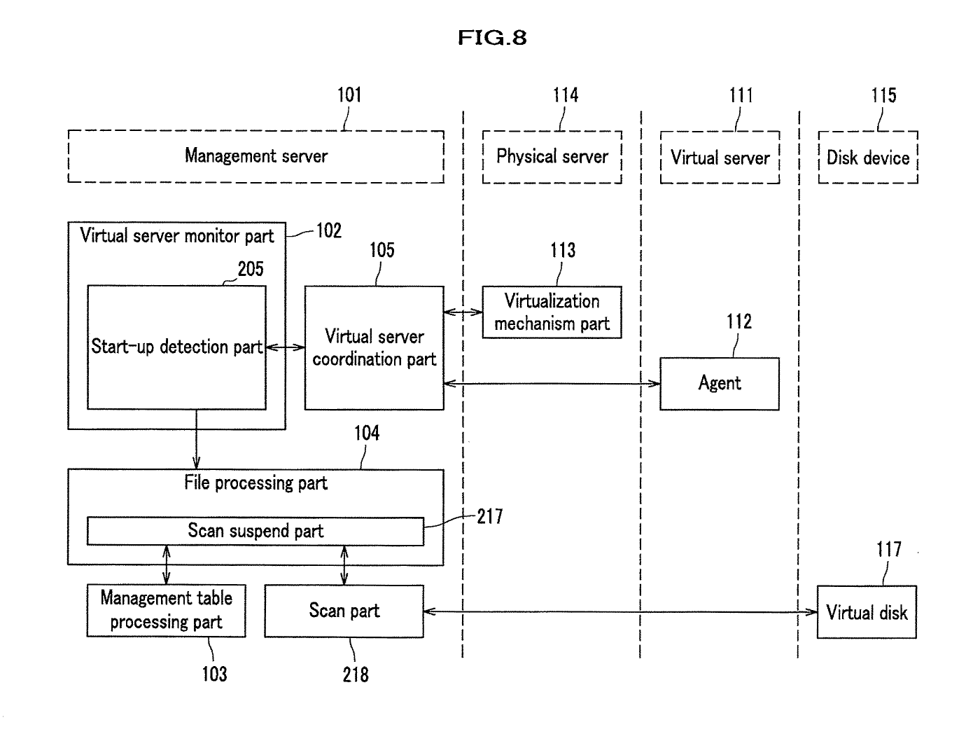

FIG. 8 is an explanatory diagram illustrating an outline of a start-up detection processing. The virtual server monitor part 102 periodically checks if there is any virtual server 111 which has been started up, using the start-up detection part 205. The start-up detection part 205 determines that there is the virtual server 111 which has been started up, by detecting a communication with the agent 112 is available using the virtual server coordination part 105. It is also possible that the start-up detection part 205 checks the start-up virtual server 111 using the virtualization mechanism part 113. If the start-up detection part 205 detects the start-up virtual server 111, the start-up detection part 205 transmits start-up virtual server information to the file processing part 104. The start-up virtual server information is, more specifically, a virtual server identifier of the detected start-up virtual server.

Upon receipt of the start-up virtual server information, the file processing part 104 of the management server 101 passes the start-up virtual server information (for example, a virtual server identifier or a virtual disk identifier) to the scan suspend part 217. The scan suspend part 217 transmits a server status acquisition request to the management table processing part 103 based on the start-up virtual server information.

Upon receipt of the server status acquisition request, the management table processing part 103 of the management server 101 transmits the scan state 506 of the detected virtual server 111 from the virtual server management table 107 to the scan suspend part 217. The scan suspend part 217 receives a result of the server status acquisition request, and if a file scan on the detected virtual server 111 is in progress, the interruption part 217 instructs the scan part 218 to interrupt the file scan. Upon instruction of the file scan, the scan part 218 interrupts the file scan on the target virtual server 111 and returns a result of the interrupted scan to the scan suspend part 217. The scan suspend part 217 transmits the scan result to the management table processing part 103 and terminates the processing. Upon receipt of the scan result, the management table processing part 103 updates the virtual server management table 107 and the file management table 108.

FIG. 9 is an explanatory diagram illustrating an outline of a start-up processing. The virtual server monitor part 102 of the management server 101 periodically checks whether or not there is any start-up coordination request using the file transmit receive part 207. The start-up coordination request used herein is a request of a processing of, for example, “resuming a scan on a virtual server which has currently been suspended”. More specifically, the virtual server monitor part 102 receives a processing of start-up coordination (a start-up coordination processing) of the virtual server coordination part 105 based on a request from the virtualization mechanism part 113 or the agent 112 when the virtual server 111 is started up according to a setting by a user.

The file transmit receive part 207 of the management server 101 receives a start-up coordination request from the virtualization mechanism part 113 or the agent 112 virtual server coordination part 105. Upon confirmation of a receipt of the start-up coordination request, the file transmit receive part 207 transmits start-up coordination virtual server information to the file processing part 104. The start-up coordination virtual server information used herein means information in which virtual server information of a requestor is added to the start-up coordination request.

Upon receipt of the start-up coordination virtual server information, the file processing part 104 of the management server 101 passes the virtual server information to the scan start part 216. The scan start part 216 transmits a file acquisition request to the management table processing part 103 based on the virtual server information. Upon receipt of the file acquisition request, the management table processing part 103 extracts a file entry from the file management table 108 and transmits the extracted file entry to the scan start part 216.

Upon receipt of the file acquisition request, the scan start part 216 performs a virus scan on the appropriate virtual disk 117 using the scan part 218. The scan part 218 returns a result of the virus scan to the scan start part 216. The scan start part 216 transmits the scan result to the management table processing part 103. Upon receipt of the scan result, the management table processing part 103 updates the virtual server management table 107 and the file management table 108. The scan start part 216 continues performing a virus scan until no more file entry is extracted as the result of the file acquisition request.

Note that the virtualization mechanism part 113 or the agent 112 issues a start-up coordination request by request from a user or on a periodic basis even while the virtual server 111 is running. This makes it possible to perform a virus scan even while the virtual server 111 is running.

FIG. 10 is an explanatory diagram illustrating an outline of a virus detection processing. If the scan part 218 of the management server 101 performs a virus scan on the virtual disk 117 and detects a virus, the scan part 218 transmits virus detection information including a virtual disk identifier of which virtual disk the virus is detected, a file identifier, a detection time, and contents of the virus, to the scan start part 216. Upon receipt of the virus detection information, the scan start part 216 generates virus infection information including a degree of risk of the virus besides the virus detection information and transmits the virus infection information to the file transmit receive part 207. The scan start part 216 and the scan part 218 then suspend the virus scan.

Upon receipt of the virus infection information, the file transmit receive part 207 of the virtual server monitor part 102 acquires virus infection server information from the management table processing part 103 based on the virus infection information and transmits the virus infection server information to the virtual server coordination part 105. More specifically, the virus infection server information includes a virtual server identifier whose virtual server uses a virtual disk infected by the virus, a virtualization mechanism identifier, a physical server identifier, and the like.

The virtual server coordination part 105 isolates the infected virtual server 111 based on the virus infection server information. The isolation used herein means that the infected virtual server 111 is prevented from a start-up or is disconnected from the network 110 according to a setting by an administrator.

FIG. 11 is an explanatory diagram illustrating an outline of a file management table update processing. If the disk I/O monitor part 304 of the agent 112 detects a file write 1101 in the virtual disk 117, the agent 112 transmits file write information to the file transmit receive part 207 via the virtual server coordination part 105. The file write information used herein means information on storage of a file written in the virtual disk 117.

Upon receipt of the file write information, the file transmit receive part 207 transmits the file write information to the management table processing part 103. Upon receipt of the file write information, the management table processing part 103 receives, generates a file identifier of the file, and, for example, searches the file management table 108 for whether or not there is a file identifier identical to the generated file identifier. If there is no identical file identifier, the management table processing part 103 adds a new row of a file entry to (or updates) the file management table 108.

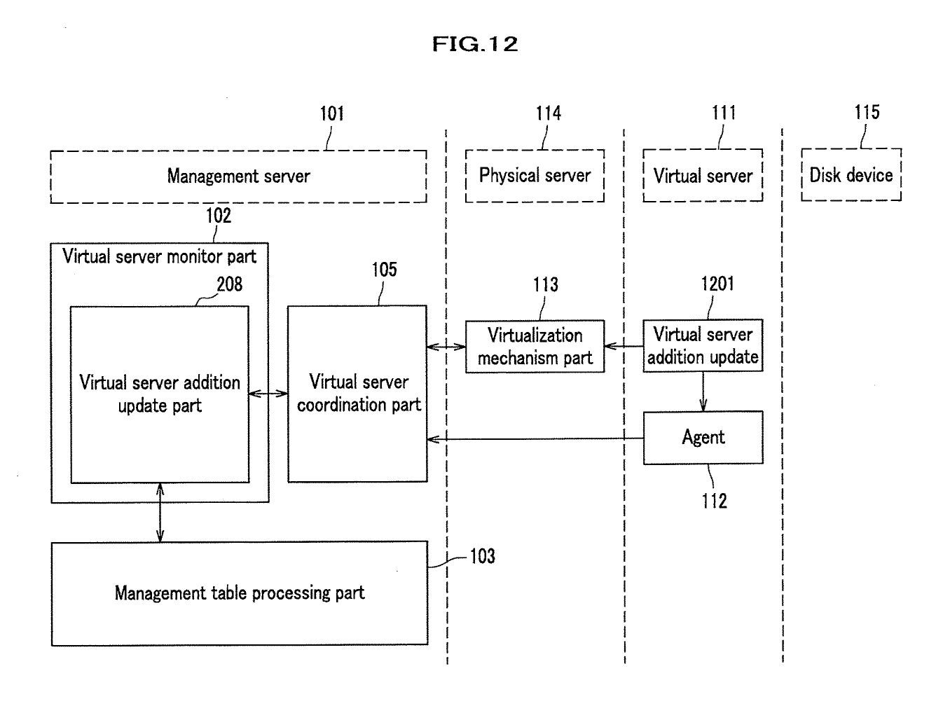

FIG. 12 is an explanatory diagram illustrating an outline of a physical server management table/management server management table addition update processing. If an addition update 1201 occurs in the virtual server 111, the virtual server coordination part 105 transmits addition update information on the virtual server 111 to the virtual server monitor part 102 in coordination with the virtualization mechanism part 113 or the agent 112.

Upon receipt of the addition update information on the virtual server 111, the virtual server monitor part 102 passes the addition update information on the virtual server 111 to the virtual server addition update part 208. The virtual server addition update part 208 transmits server addition update information to the management table processing part 103, based on the virtual server addition update information. The virtual server addition update information is, more specifically, an added or updated virtual or physical server identifier or the like. The server addition update information includes a time when an addition or an update is performed besides the virtual server addition update information.

Upon receipt of the server addition update information, the management table processing part 103 passes the server addition update information to the server entry addition update part 211. The server entry addition update part 211 searches the physical server management table 106 (see FIG. 4) and the virtual server management table 107 (see FIG. 5) for a physical server identifier and a virtual server identifier in the server addition update information, respectively, and newly enters (or updates) appropriate data. More specifically, if Virtual Server 4 is newly added, for example, a row of a server entry for Virtual Server 4 is added to the virtual server management table 107.

Next are described major processing control flows.

FIG. 13 is a flowchart illustrating an overall processing performed by the virtual server monitor part 102. FIG. 13 is used for further explaining the outlines of FIG. 7 to FIG. 12. The flowchart of FIG. 13 illustrates the overall processing including relationship with the processings performed by the start-up detection part 205 (see FIG. 15), the inactive detection part 206 (see FIG. 16), the file transmit receive part 207 (see FIG. 14), and the virtual server addition update part 208 (see FIG. 17).

The virtual server monitor part 102 performs a state monitor processing of the virtual server 111 by the inactive detection part 206 and the start-up detection part 205 (see FIG. 7 and FIG. 8, respectively), a processing in response to a file transmit/receive request by the virtual server coordination part 105 (see FIG. 9 and FIG. 11), and a processing in response to a file transmit/receive request by the file processing part 104 (see FIG. 10). The file transmit/receive request used herein includes the start-up coordination request (start-up coordination request information), the virus infection information, and the file write information.

For example, the start-up coordination request is, more specifically, a request of making the virtual server coordination part 105 perform the start-up coordination processing when the virtual server 111 is started up in accordance with a user's setting. The start-up coordination processing used herein means that a virus scan on the virtual server 111 having been started up has been suspended but is to be currently proceeded with.

The virus infection information used herein is, more specifically, information on virus infection obtained when the file processing part 104 detects a virus by the scan part 218. The file write information used herein is, more specifically, information on a file write obtained when the disk I/O monitor part 304 of the agent 112 detects a write on a file.

In step S1301, the virtual server monitor part 102 executes the start-up detection part 205, and the start-up detection part 205 acquires, if any, the virtual server 111 which has been started-up. In step S1302, the start-up detection part 205 determines whether or not there is any started-up virtual server. If there is a started-up virtual server (if Yes in step S1302), the start-up detection part 205 advances the processing to step S1303. In step S1303, the start-up detection part 205 transmits the start-up virtual server information to the file processing part 104 and advances the processing to step S1304. On the other hand, in step S1302, if there is not any started-up virtual server (if No in step S1302), the start-up detection part 205 advances the processing to step S1304.

In step S1304, the virtual server monitor part 102 executes the inactive detection part 206. The inactive detection part 206 acquires, if any, the virtual server 111 which is inactive. In step S1305, the inactive detection part 206 determines whether or not there is any inactive virtual server. If there is an inactive virtual server (if Yes in step S1305), the inactive detection part 206 advances the processing to step S1306. In step S1306, the inactive detection part 206 transmits the inactive virtual server information to the file processing part 104 and advances the processing to step S1307. On the other hand, in step S1305, if there is no inactive virtual server (if No in step S1305), the inactive detection part 206 advances the processing to step S1307.

In step S1307, the file transmit receive part 207 of the virtual server monitor part 102 determines whether or not there is any file transmit/receive request. The file transmit/receive request is made, for example, when a start-up coordination processing is performed or a virus is detected. If there is a file transmit/receive request (if Yes in step S1307), the file transmit receive part 207 advances the processing to step S1308. In step S1308, the file transmit receive part 207 performs the processing shown in FIG. 14 and advances the processing to step S1309.

In step S1309, the virtual server addition update part 208 of the virtual server monitor part 102 determines whether or not there is any virtual server 111 added or updated. If the virtual server 111 is added or updated (if Yes in step S1309), the virtual server addition update part 208 advances the processing to step S1310. In step S1310, the virtual server addition update part 208 performs the processing shown in FIG. 17 and returns the processing to step S1301. Then, the virtual server monitor part 102 repeatedly continues to run. On the other hand, in step S1309, if no virtual server 111 is added or updated (if No in step S1309), the processing returns to step S1301.

FIG. 14 is a flowchart illustrating a processing performed by the file transmit receive part 207 of the virtual server monitor part 102. In step S1401, the file transmit receive part 207 determines whether or not the file transmit request is on the virus infection information. If the file transmit request is on the virus infection information (if yes in step S1401), the file transmit receive part 207 advances the processing to step S1402. And if not (if No in step S1401), the file transmit receive part 207 advances the processing to step S1404.

In step S1402, the file transmit receive part 207 acquires virus infection server information from the management table processing part 103 based on information on the virus detection. In step S1403, the file transmit receive part 207 transmits the virus infection server information acquired in step S1402 to the virtual server coordination part 105.

In step S1404, the file transmit receive part 207 determines whether or not the file transmit request is on a start-up coordination request. If the file transmit request is on the start-up coordination request (if Yes in step S1404), the file transmit receive part 207 advances the processing to step S1405. And if not (if No in step S1404), the file transmit receive part 207 advances the processing to step S1407. In step S1405, the file transmit receive part 207 adds the virtual server information of a requestor to the start-up coordination request, to thereby generate start-up coordination virtual server information. In step S1406, the file transmit receive part 207 transmits the start-up coordination virtual server information generated in step S1405 to the file processing part 104 and terminates the processing.

In step S1407, the file transmit receive part 207 determines whether or not the file transmit request is on the file write information. If the file transmit request is on the file write information (if Yes in step S1407), the file transmit receive part 207 advances the processing to step S1408. In step S1408, the file transmit receive part 207 transmits the file write information to the management table processing part 103 and terminates the processing. On the other hand, if the file transmit request is not on the file write information (if No in step S1407), the file transmit receive part 207 terminates the processing.

FIG. 15 is a flowchart illustrating a processing performed by the start-up detection part 205 of the virtual server monitor part 102. In step S1501, the start-up detection part 205 acquires the virtual server which has been started up, from the virtual server coordination part 105 and terminates the processing.

FIG. 16 is a flowchart illustrating a processing performed by the inactive detection part 206 of the virtual server monitor part 102. In step S1601, the inactive detection part 206 acquires the virtual server 111 in the inactive state from the virtual server coordination part 105 and terminates the processing.

FIG. 17 is a flowchart illustrating a processing performed by the virtual server addition update part 208 of the virtual server monitor part 102. In step S1701, the virtual server addition update part 208 acquires the server addition update information of the virtual server 111 from the virtual server coordination part 105. In step S1702, the virtual server addition update part 208 transmits the server addition update information acquired in step S1701 to the management table processing part 103 and terminates the processing.

FIG. 18 is a flowchart illustrating a processing performed by the file processing part 104. In step S1801, the file processing part 104 receive information from the virtual server coordination part 105 or the like. In step S1802, the file processing part 104 determines whether or not the received information as a result is start-up coordination virtual server information. If the result is the start-up coordination virtual server information (if Yes in step S1802), the file processing part 104 advances the processing to step S1804. And if the result is not the start-up coordination virtual server information (if No in step S1802), the file processing part 104 advances the processing to step S1803.

In step S1803, the file processing part 104 determines whether or not the received result is the inactive virtual server information. If the result is the inactive virtual server information (if Yes in step S1803), the file processing part 104 advances the processing to step S1804. And if not the inactive virtual server information (if No in step S1803), the file processing part 104 advances the processing to step S1805.

In step S1804, the file processing part 104 generates virtual server information from the start-up coordination virtual server information or the inactive virtual server information, passes the generated virtual server information to the scan start part 216, and advances the processing to step S1805.

In step S1805, the file processing part 104 determines whether or not the received result is start-up virtual server information. If the result is the start-up virtual server information (if Yes in step S1805), the file processing part 104 advances the processing to step S1806. And if not the start-up virtual server information (if No in step S1805), the file processing part 104 returns the processing to step S1801.

In step S1806, the file processing part 104 generates virtual server information from the start-up virtual server information, passes the generated virtual server information to the scan suspend part 217, and returns the processing to step S1801. Then, the file processing part 104 repeatedly continues to run.

FIG. 19 is a flowchart illustrating a processing performed by the scan start part 216 of the file processing part 104. In step S1901, the scan start part 216 transmits a file acquisition request to the management table processing part 103 based on the virtual server information and acquires, if any, a file entry of a virus scan target file.

In step S1902, the scan start part 216 determines whether or not there is any file entry acquired in step S1901. If there is any file entry (if Yes in step S1902), the scan start part 216 advances the processing to step S1903. And if not (if No in step S1902), the scan start part 216 terminates the processing because there is no need for a virus scan.

In step S1903, the scan start part 216 executes the scan part 218 on a file having the file entry acquired in step S1902. In step S1904, the scan start part 216 determines whether or not a virus is detected as a result of the scan performed in step S1903. If a virus is detected in the scan result (if Yes in step S1904), the scan start part 216 advances the processing to step S1906. And if not (if No in step S1904), the scan start part 216 advances the processing to step S1905.

In step S1906, the scan start part 216 transmits the obtained virus infection information to the virtual server monitor part 102 and suspends the processing.

In step S1905, the scan start part 216 transmits the scan result obtained in step S1903 to the management table processing part 103, returns the processing to step S1901, and continues the processing.

FIG. 20 is a flowchart illustrating a processing performed by the scan suspend part 217 of the file processing part 104. In step S2001, the scan suspend part 217 transmits a server status acquisition request to the management table processing part 103 based on the virtual server information and acquires scan information on the target virtual server 111 from the management table processing part 103.

In step S2002, the scan suspend part 217 determines whether or not the scan information acquired in step S2001 indicates a scan in progress. If the scan information indicates a scan in progress (if Yes in step S2002), the scan suspend part 217 advances the processing to step S2003. If the scan information does not indicate a scan in progress (if No in step S2002), the scan suspend part 217 terminates the processing.

In step S2003, the scan suspend part 217 instructs the scan part 218 to suspend the virus scan performed by the scan part 218 on the target virtual server 111. In step S2004, the scan suspend part 217 transmits a result of the scan suspended in step S2003 to the management table processing part 103 and terminates the processing.

FIG. 21 and FIG. 22 are flowcharts illustrating a processing performed by the management table processing part 103 according to the first embodiment. In step S2101, the management table processing part 103 receives various types of information. In step S2102, the management table processing part 103 determines whether or not the received information is a server status acquisition request. If the information is a server status acquisition request (if Yes in step S2102), the management table processing part 103 advances the processing to step S2103. And if not (if No in step S2102), the management table processing part 103 advances the processing to step S2105.

In step S2103, the management table processing part 103 passes an appropriate virtual server identifier to the server entry extraction part 212. In step S2104, the management table processing part 103 acquires a result of the extraction in step S2103 and transmits (returns) the extraction result to a caller and terminates the processing.

In step S2105, the management table processing part 103 determines whether or not the received information is a file acquisition request. If the information is a file acquisition request (if Yes in step S2105), the management table processing part 103 advances the processing to step S2106. And if not (if No in step S2105), the management table processing part 103 advances the processing to step S2108. In step S2106, the management table processing part 103 passes an appropriate virtual server identifier to the file entry extraction part 210. In step S2107, the management table processing part 103 acquires a result of the extraction in step S2106, transmits (returns) the extraction result to a caller, and terminates the processing.

In step S2108, the management table processing part 103 determines whether or not the received information is virus infection information. If the information is virus infection information (if Yes in step S2108), the management table processing part 103 advances the processing to step S2109. And if not (if No in step S2108), the management table processing part 103 advances the processing to step S2201 (see FIG. 22). In step S2109, the management table processing part 103 passes a file identifier in the virus infection information to the server entry extraction part 212. In step S2110, the management table processing part 103 acquires a result of the extraction performed in step S2109, transmits (returns) the extraction result to a caller, and terminates the processing.

Explanation of the processing is next made with reference to FIG. 22. In step S2201, the management table processing part 103 determines whether or not the received information is a scan result. If the received information is a scan result (if Yes in step S2201), the management table processing part 103 advances the processing to step S2202. And if not (if No in step S2201), the management table processing part 103 advances the processing to step S2203. In step S2202, the management table processing part 103 passes the scan result to the file entry addition update part 209 and terminates the processing.

In step S2203, the management table processing part 103 determines whether or not the received information is file write information. If the received information is file write information (if Yes in step S2203), the management table processing part 103 advances the processing to step S2204. And if not (if No in step S2203), the management table processing part 103 advances the processing to step S2205. In step S2204, the management table processing part 103 passes the file write information to the file entry addition update part 209 and terminates the processing.

In step S2205, the management table processing part 103 determines whether or not the received information is server addition update information. If the received information is server addition update information (if Yes in step S2205), the management table processing part 103 advances the processing to step S2206. And if not (if No in step S2205), the management table processing part 103 terminates the processing. In step S2206, the management table processing part 103 passes the server addition update information to the server entry addition update part 211 and terminates the processing.

FIG. 23 is a flowchart illustrating a processing performed by the file entry addition update part 209 of the management table processing part 103. The file entry addition update part 209 adds and updates a file entry to the file management table 108 based on a scan result or file write information.

In step S2301, the file entry addition update part 209 makes the file identifier generation part 213 generate a file identifier. In step S2302, the file entry addition update part 209 searches the file management table 108 using a virtual server identifier and a file identifier as keys.

In step S2303, the file entry addition update part 209 determines whether or not there is any file entry as a result of step S2302. If a file entry is present (if Yes in step S2303), the file entry addition update part 209 advances the processing to step S2304. And if not (if No in step S2303), the file entry addition update part 209 advances the processing to step S2305. In step S2304, the file entry addition update part 209 updates a file entry in the file management table 108 based on the passed information (for example, a scan result) and terminates the processing. On the other hand, in step S2305, the file entry addition update part 209 adds a file entry in the passed information to the file management table 108 and terminates the processing.

FIG. 24 is a flowchart illustrating a processing performed by the file entry extraction part 210 of the management table processing part 103. The file entry extraction part 210 returns a file entry in accordance with a condition of extracting a file entry.

In step S2401, the file entry extraction part 210 acquires a condition of extracting a file entry from the processing definition file 109. In step S2402, the file entry extraction part 210 searches the file management table 104 using the condition of extracting a file entry acquired in step S2401 and a virtual server identifier as keys.

In step S2403, the file entry extraction part 210 determines whether or not there is any file entry as a result of step S2402. If there is a file entry (if Yes in step S2403), the file entry extraction part 210 advances the processing to step S2404. And if not (if No in step S2403), the file entry extraction part 210 advances the processing to step S2405. In step S2404, the file entry extraction part 210 returns the searched file entry and terminates the processing. On the other hand, in step S2405, the file entry extraction part 210 returns a data indicating that there is no file entry (for example, a null) and terminates the processing.

FIG. 25 is a flowchart illustrating a processing performed by the server entry addition update part 211 of the management table processing part 103. The server entry addition update part 211 adds and updates server entries to the physical server management table 106 and the virtual server management table 107 based on the server addition update information.

In step S2501, the server entry addition update part 211 searches the physical server management table 106 using a physical server identifier as a key. In step S2502, the server entry addition update part 211 determines whether or not there is any server entry (physical server entry) as a result of step S2501. If there is a server entry (if Yes in step S2502), the server entry addition update part 211 advances the processing to step S2503. And if not (if No in step S2502), the server entry addition update part 211 advances the processing to step S2504.

In step S2503, the server entry addition update part 211 updates a physical server entry in the physical server management table 106 based on the server entry searched in step S2501 and advances the processing to step S2505. On the other hand, in step S2504, the server entry addition update part 211 adds a physical server entry in the passed server addition update information to the physical server management table 106 and advances the processing to step S2505.

In step S2505, the server entry addition update part 211 searches the virtual server management table 107 using an appropriate virtual server identifier as a key. In step S2506, the server entry addition update part 211 determines whether or not there is any server entry (virtual server entry) as a result of step S2505. If there is a server entry (if Yes in step S2506), the server entry addition update part 211 advances the processing to step S2507. And if not (if No in step S2506), the server entry addition update part 211 advances the processing to step S2508.

In step S2507, the server entry addition update part 211 updates a virtual server entry in the virtual server management table 107 based on the server entry searched in step S2505 and terminates the processing. On the other hand, in step S2508, the server entry addition update part 211 adds a virtual server entry in the passed server addition update information to the virtual server management table 107 and terminates the processing.

FIG. 26 is a flowchart illustrating a processing performed by the server entry extraction part 212 of the management table processing part 103. The server entry extraction part 212 returns a list of a virtual server entry containing the passed file identifier.

In step S2601, the server entry extraction part 212 searches the file management table 108 using a file identifier as a key and acquires an appropriate virtual disk identifier. In step S2602, the server entry extraction part 212 acquires an appropriate virtual server identifier from the virtual server management table 107 using the virtual disk identifier acquired step S2601 as a key.

In step S2603, the server entry extraction part 212 adds the virtual server identifier acquired in step S2602 to a result list which is a list of a result of the extraction. In step S2604, the server entry extraction part 212 determines whether or not the file entry in processing is the last file entry as a result of step S2601. If the file entry in processing is the last one (if Yes in step S2604), in step S2605, the server entry extraction part 212 returns the result list in step S2603 and terminates the processing. On the other hand, if the file entry in processing is not the last one (if No in step S2604), the server entry extraction part 212 returns the processing to step S2601 and repeats the processing.

FIG. 27 is a flowchart illustrating a processing performed by the file identifier generation part 213 of the management table processing part 103. The file identifier generation part 213 generates a file identifier which uniquely specifies a file.

In step S2701, the file identifier generation part 213 generates a hash of a specified file. In the present invention, a hash is generated using, for example, the MD5 algorithm or the SHA1 algorithm. In step S2702, the file identifier generation part 213 returns the hash generated in step S3102 as a file identifier of the specified file and terminates the processing.

The virtual server management system according to this embodiment is a system in which the physical server 114 and the disk device 115 are coupled with each other via the management server 101 and the network 110. The physical server 114 includes the virtualization mechanism part 113 which is capable of creating one or more virtual servers 111. The virtual server 111 has the virtual disk 117 to which an area of the disk device 115 owned by the physical server 114 is allocated.

The management server 101 can identify the virtual disk 117 allocated to the virtual server 111 in correspondence with the virtual server 111 in the inactive state and perform a virus scan on the virtual disk 117. The management server 101 can also manage a result of the virus scan.

The management server 101 can: store the virtual server management table 107 (which may also be referred to as virtual server information) which associates the virtual server 111, the virtualization mechanism part 113, and the virtual disk 117 with one another, in a storage part (for example, the memory 201A); inquire of the virtualization mechanism part 113 for an operational state of the virtual server 111 which indicates whether the virtual server 111 is started up or is inactive; identify, if the operational state in response to the inquiry is detected as inactive, the virtual disk 117 allocated to the inactive virtual server 111 based on the virtual server management information; and start a virus scan on the identified virtual disk 117.

If a virus scan is performed by the OS of the virtual server 111 as in the conventional art, the virus scan cannot be performed without starting up a virtual server. In this embodiment, however, a virus scan can be performed on the virtual disk 117 allocated to the inactive virtual server 111 without starting up the inactive virtual server 111 itself.

### Second Embodiment

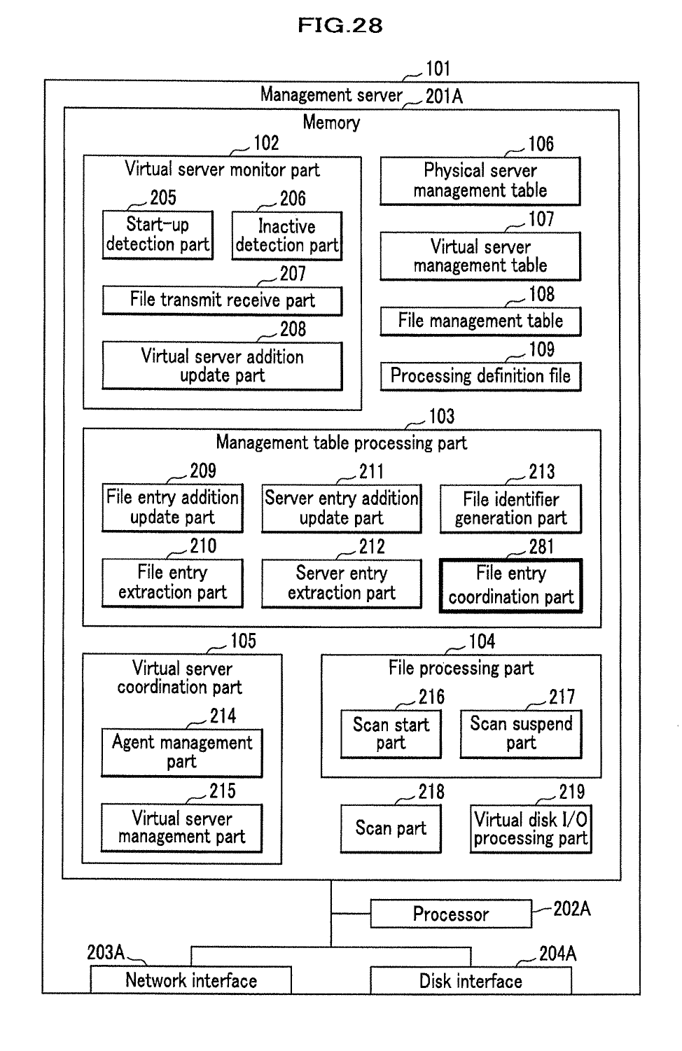

FIG. 28 is a detailed diagram illustrating a configuration of a management server 101 according to a second embodiment. In the second embodiment, a result of a virus scan is used for updating all file entries having the same file identifiers. The configuration according to the second embodiment is the same as that according to the first embodiment shown in FIG. 2 except that a file entry coordination part 281 is additionally included in the management table processing part 103. The file entry coordination part 281 updates a file entry of a file identifier present in one virtual disk of which file identifier is also present in another virtual disk.

According to the second embodiment, in an environment in which the same OS 301 (see FIG. 3) operates in each of a plurality of virtual servers 111, a virus scan on a plurality of the same files is required to be performed just once. This makes it possible for an entire system to reduce a time for a virus scan.

In the virtual server 111 in operation, it is enough to perform a virus scan only on a unique file. This can further reduce a time for a virus scan.

A virus scan in the virtual disk 117 on the inactive virtual server 111 has an advantageous effect that the virus scan is also applied to the virtual server 111 in operation. The effect can be obtained not only from a virus scan on the inactive virtual server 111 but also from the virtual server 111 in operation.

This embodiment describes an embodiment of processing steps in the management table processing part 103 and the file entry coordination part 281.

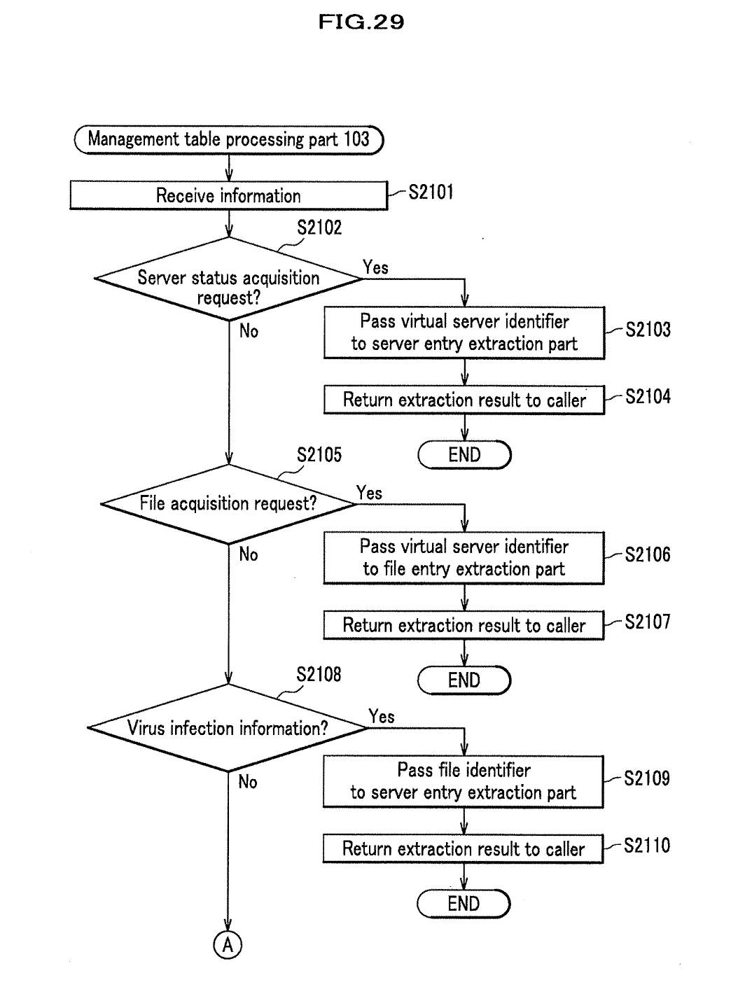

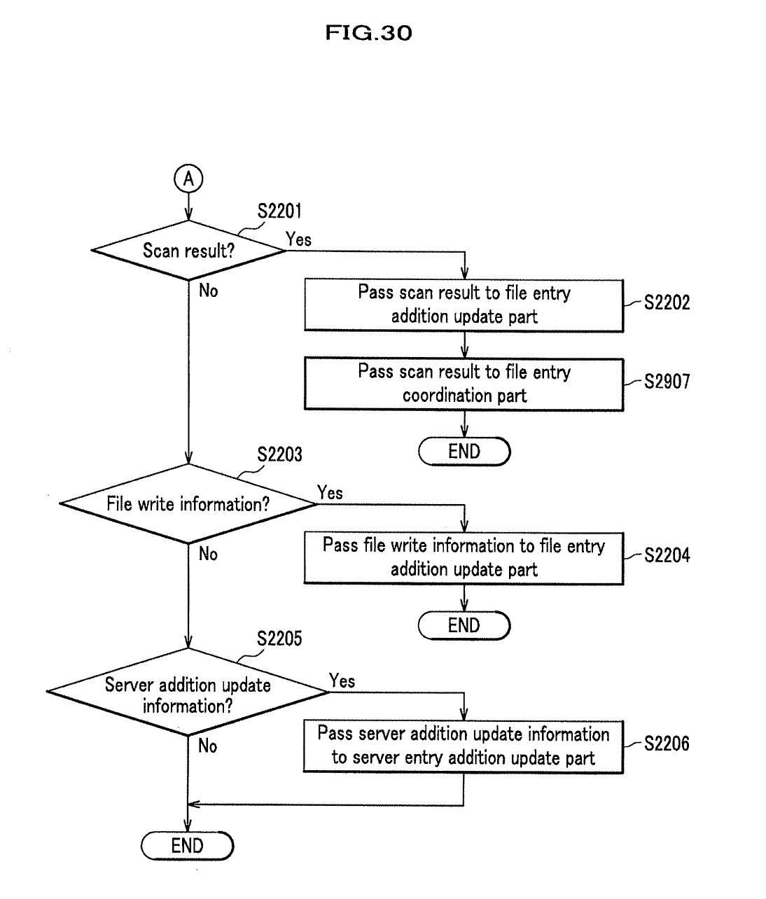

FIG. 29 and FIG. 30 are flowcharts illustrating a processing performed by the management table processing part 103 according to the second embodiment. The processing shown in FIG. 29 and FIG. 30 is the same as that shown in FIG. 21 and FIG. 22 except that step S2907 of FIG. 30 is additionally included in the second embodiment. The same reference numerals are given to the steps shown in FIG. 29 and FIG. 30 as the steps shown in FIG. 21 and FIG. 22, and description thereof is omitted herefrom.

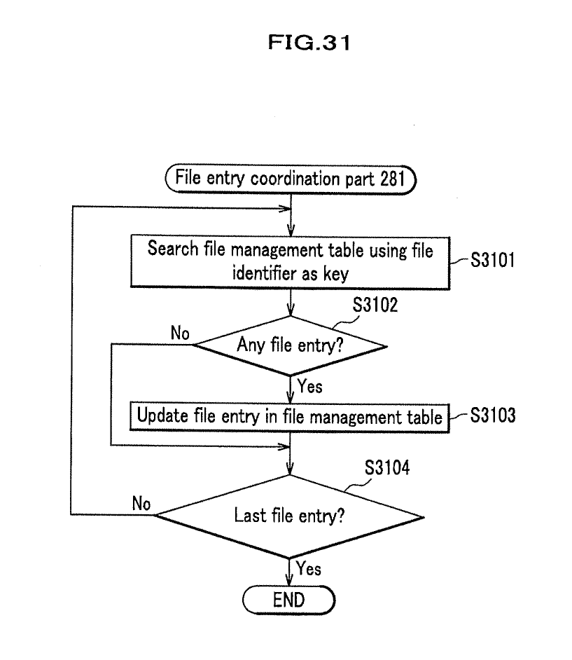

In FIG. 22, after step S2202, the processing is terminated. In FIG. 30, however, in step S2907, the management table processing part 103 passes the scan result to the file entry coordination part 281 and terminates the processing. A processing performed by the file entry coordination part 281 is described with reference to FIG. 31.

FIG. 31 is a flowchart illustrating a processing performed by the file entry coordination part 281 of the management table processing part 103. The file entry coordination part 281 updates all file entries registered in the file management table 108 based on a scan result.

In step S3101, the file entry coordination part 281 searches the file management table 108 using a file identifier as a key. In step S3102, the file entry coordination part 281 determines whether or not there is any file entry as a result of step S3101. If there is a file entry (if Yes in step S3102), the file entry coordination part 281 advances the processing to step S3103. And if not (if No in step S3102), the file entry coordination part 281 advances the processing to step S3104.

In step S3103, the file entry coordination part 281 updates contents of the file entry acquired in step S3101. In step S3104, the file entry coordination part 281 determines whether or not the file entry in processing is the last file entry as a result of step S3101. If the file entry in processing is not the last one (if No in step S3104), the file entry coordination part 281 returns the processing to step S3101 and repeats the processing. On the other hand, if the file entry in processing is the last one (if Yes in step S3104), the file entry coordination part 281 terminates the processing.

The virtual server management system according to this embodiment makes it possible to reduce a time required for a virus scan in the system as a whole, by sharing results of performing the virus scan on the same files present in the virtual disks 117 in all of the virtual servers 111 managed by the management server 101.

This embodiment is modified is modified according to a state of the virtual server 111 with respect to a virus scan function. However, this embodiment is also applied to a backup function instead of the virus scan function. For example, a configuration is possible in which the management server 101 manages a state of backup similarly to that of a virus scan, and a backup processing is performed only once on the same files present in the virtual disks 117 in all of the virtual servers 111 managed by the management server 101. This can reduce a time required for a backup of the whole system.

According to this embodiment, in a virtual server environment, a management server can perform a virus scan on a virtual disk allocated to a virtual server and thus ensure security regardless of whether or not the virtual server is running.

### DESCRIPTION OF REFERENCE NUMERALS

101 management server
102 virtual server monitor part
103 management table processing part
104 file processing part
105 virtual server coordination part
106 physical server management table
107 virtual server management table (virtual server management information)
108 file management table (file management information)
109 processing definition file
110 network
111 virtual server
112 agent
113 virtualization mechanism part
114 physical server (server device)
115 disk device
116 disk volume
117 virtual disk
201A, 201B memory (storage part)
202A, 202B processor
203A, 203B network interface
204A, 204B disk interface
205 start-up detection part
206 inactive detection part
207 file transmit receive part
208 virtual server addition update part
209 file entry addition update part
210 file entry extraction part
211 server entry addition update part
212 server entry extraction part
213 file identifier generation part
214 agent management part
215 virtual server management part
216 scan start part
217 scan suspend part
218 scan part
219 virtual disk I/O processing part
281 file entry coordination part
301 OS
302 notification part
303 coordination part
304 disk I/O monitor part

1. A security management method in a virtualized environment, the security management method performed in a system in which one or more server devices are coupled to a disk device; the server device includes a virtualization mechanism part which is capable of creating and managing one or more virtual servers; the virtual server has a virtual disk to which an area of the disk device is allocated; and a management server is coupled to the server device and the disk device via a network, the management server performing a virus scan on the virtual disk and managing security of the system, the security management method comprising the steps, performed by the management server, of:
storing, in a storage part, virtual server management information in which the virtual server, the virtualization mechanism part, the virtual disk, and a state of a virus scan on the virtual disk are associated with each other;
inquiring of the virtualization mechanism part for an operational state of the virtual server, the operational state indicating whether the virtual server is started up or is inactive;
identifying, if the operational state in response to the inquiry is detected as inactive, the virtual disk allocated to the inactive virtual server based on the association in the virtual server management information; and
starting a virus scan on the identified virtual disk.

2. The security management method in a virtualized environment according to claim 1, further comprising the steps, performed by the management server, of:
registering, when the management server starts the virus scan on the identified virtual disk, the state of the virus scan on the virtual disk as “in progress”, in the virtual server management information;
identifying, if the operational state in response to the inquiry is detected as inactive, the virtual disk allocated to the inactive virtual server based on the virtual server management information; and
suspending, if the state of the virus scan on the virtual disk is in progress, the virus scan on the virtual disk, and registering the state of the virus scan as being suspended, in the virtual server management information.

3. The security management method in a virtualized environment according to claim 2, further comprising the step, performed by the management server, of resuming the virus scan on the virtual disk, if the state of the virus scan in the virtual server management information is being suspended and a request of resuming the virus scan after the virtual server is started is received from the virtualization mechanism part.

4. The security management method in a virtualized environment according to claim 1, further comprising the steps, performed by the management server, of
identifying, if a virus infection is detected on the virtual disk, a virtual server associated with the virtual disk on which the virus infection has been detected, based on the virtual server management information; and
isolating the identified virtual server as an virus-infected virtual server.

5. The security management method in a virtualized environment according to claim 1, further comprising the steps, performed by the management server, of
storing, in the storage part, file management information in which the virtual disk, a file identifier which identifies a file stored in the virtual disk, storage information on the file, and a result of performing the virus scan on the file are associated with each other;
registering, after the virus scan on the virtual disk is started, the result of performing the virus scan on the file in the virtual disk, in the file management information; and
updating a state of the result of performing the virus scan on a file which has a file identifier identical to the file identifier of the virus-scanned file and stored in a virtual disk in an other virtual server, based on the file management information.

6. A security management system in which one or more server devices are coupled to a disk device; the server device includes a virtualization mechanism part which is capable of creating and managing one or more virtual servers; the virtual server has a virtual disk to which an area of the disk device is allocated; and a management server coupled to the server device and the disk device via a network performs a virus scan on the virtual disk and manages security of the virtual server,
wherein the management server
stores, in a storage part, virtual server management information in which the virtual server, the virtualization mechanism part, the virtual disk, and a state of a virus scan on the virtual disk are associated with each other;
inquires of the virtualization mechanism part for an operational state of the virtual server, the operational state indicating whether the virtual server is started up or is inactive;
identifies, if the operational state in response to the inquiry is detected as inactive, the virtual disk allocated to the inactive virtual server based on the association in the virtual server management information; and
starts a virus scan on the identified virtual disk.

7. The security management system according to claim 6,
wherein the management server
registers, when the management server starts the virus scan on the identified virtual disk, the state of the virus scan on the virtual disk as “in progress”, in the virtual server management information;
identifies, if the operational state in response to the inquiry is detected as inactive, the virtual disk allocated to the inactive virtual server based on the virtual server management information; and
suspends, if the state of the virus scan on the virtual disk is in progress, the virus scan on the virtual disk, and registers the state of the virus scan as being suspended, in the virtual server management information.

8. The security management system according to claim 6,
wherein the management server resumes the virus scan on the virtual disk, if the state of the virus scan in the virtual server management information is suspended and a request of resuming the virus scan after the virtual server is started is received from the virtualization mechanism part.

9. The security management system according to claim 6,
wherein the management server
identifies, if a virus infection is detected on the virtual disk, a virtual server associated with the virtual disk on which the virus infection has been detected, based on the virtual server management information; and
isolates the identified virtual server as an virus-infected virtual server.

10. The security management system according to claim 6,
wherein the management server
stores, in the storage part, file management information in which the virtual disk, a file identifier which identifies a file stored in the virtual disk, storage information on the file, and a result of performing the virus scan on the file are associated with each other;
registers, after the virus scan on the virtual disk is started, the result of performing the virus scan on the file in the virtual disk, in the file management information; and
updates a state of the result of performing the virus scan on a file which has a file identifier identical to the file identifier of the virus-scanned file and is stored in a virtual disk in an other virtual server, based on the file management information.

11. A management server in a system in which one or more server devices are coupled to a disk device; the server device includes a virtualization mechanism part which is capable of creating and managing one or more virtual servers; the virtual server has a virtual disk to which an area of the disk device is allocated; and the management server coupled to the server device and the disk device via a network is provided, the management server performing a backup processing of the virtual disk and managing security of the system, the management server
storing, in a storage part, virtual server management information in which the virtual server, the virtualization mechanism part, the virtual disk, and a state of a virus scan on the virtual disk are associated with each other;
inquiring of the virtualization mechanism part for an operational state of the virtual server, the operational state indicating whether the virtual server is started up or is inactive;
identifying, if the operational state in response to the inquiry is detected as inactive, the virtual disk allocated to the inactive virtual server based on the association in the virtual server management information; and
starting a backup processing of the identified virtual disk.
